(19) United States
(12) Patent Application Publication
(10) Pub. No.: US 2024/0127592 A1
(43) Pub. Date: Apr. 18, 2024

(54) SYSTEM AND METHOD FOR GENERATING A REAL-TIME SCORE OF A PERFORMANCE

(71) Applicant: Glenn Kingsbury, Waterford Works, NJ (US)

(72) Inventor: Glenn Kingsbury, Waterford Works, NJ (US)

(21) Appl. No.: 18/457,850

(22) Filed: Aug. 29, 2023

Related U.S. Application Data
(60) Provisional application No. 63/401,965, filed on Aug. 29, 2022.

(51) Int. Cl. G06V 20/40

(52) U.S. Cl. CPC G06V 20/42; G06V 2201/07

(57) ABSTRACT

A system and method for generating a real-time score of a performance based upon one or more scores provided by one or more judges, with at least one judge watching and scoring the performance live, and with at least one judge watching and scoring a recoding of the performance. A combined or final score is output in real-time to a display.

### FIELD OF THE DISCLOSURE

The present disclosure generally relates to a system and method for generating a real-time score of a performance.

### BACKGROUND

Current methods to evaluate and score a performance of a performer, or team during a competition, such as cheerleading, gymnastics, figure skating, diving, snowboarding, skiing or other competition are typically based on a judge's subjective evaluation based on a real-time observation of the performance and defined criteria for the sport. Such evaluations may be inaccurate due to the rapid speed of the performance and the need for judges to make split-second determinations on the performer's execution of a routine. This problem is exacerbated by ever-changing scoring rubrics that change the criteria and evaluation parameters for judges.

Current competition judging methods typically use a panel of judges. For example, in team cheerleading competitions, a panel of 6 to 12 judges are typically used to evaluate the performance of the participants. These judges are each assigned a portion of the performance, such as, difficulty, execution, deductions, and overall performance. In judging a team cheerleading performance, for example, a sub-set of the panel of judges may evaluate a performance attribute such as building skills (which can include stunts, pyramids, tosses, and stunt quality), while a different sub-set may evaluate the performance attribute such as tumbling skills (which can include standing tumbling, running tumbling and jumps), and still another sub-set may evaluate the performance attribute of such as overall routine (which may include routine composition, performance, and dance).

Conventionally, judges watch the routine, or performance, from the beginning and begin to make notes on scrap paper or on paper forms. As judges notice things relevant to their scoresheets, the judges may turn to an electronic device capable of playing back a video recording of the performance thus enabling the judge to rewatch portions of the performance. The judge may replay all or part of the recorded performance at their discretion to review missed parts of the performance or to review other parts of the performance to satisfy themselves that their score is accurate and appropriate.

It is not uncommon for a judge to rely on the recoding of the performance when the judge has taken their eyes off of the live performance to attend to scoring, reviewing judging criteria, the rubric, etc., or when the judge is otherwise distracted from watching the live performance. In such instances a judge must rely on the recording of the performance to view and judge parts that the judge did not observe live. Here the judge is out of sync with the live performance and must rely on the viewing device to evaluate the performance. Thus, the use of a viewing device, by a judge, often causes the judge to be reliant on the recorded version of the performance rather than evaluating the live performance. As such, a judge may not see the actual performance, except through the electronic device.

Furthermore, the process of determining a final score for a performance may take some significant time due to the specific rubric required to determine the performance score considering the judged attributes of the performance.

When the performance routine is complete, the judges need to transcribe their notes onto a judging form or other tabulation system. As the judges are transcribing their scores, the judges typically review rubrics, charts and definitions to find the correct point scores. Next the judges typically refer to their notes and assess the value of one or more techniques and assign theri value. The completed form is confirmed by the head judge and then tabulated by a system which double checks the scores. The scoresheet may then be given to a score check team.

If team coaches have questions about the score, the score check team reviews the judging form and video recording to determine whether the scores are reasonably reflective of the performance and may make adjustments or modifications to the judging form based on the review. If there are plain errors the paper is initialed and given back to the score check team to revise and reprint the scoresheet to hand to the judges. The scores are then tabulated and arranged to identify which team performed the best relative to each other.

Present methods and systems for generating a real-time score of a performance are deficient for the reasons identified in the preceding paragraphs. Namely, the likely inability of a judge to view an entire performance in real-time—rather referring on review of a video recording for judging at least parts of the performance. The challenges associated with collecting, validating and aggregating scores from a plurality of judges and generating a score for the performance in a reasonable amount of time following completion of the performance.

### BRIEF SUMMARY OF THE DISCLOSURE

As described herein, there is disclosed a method and system for generating a real-time score of a performance. In an embodiment the inventive method comprise generating, by a processor of a computing device, a first score of the performance based upon a score from a first judge, generating, by the processor, a second score of the performance, combining, by the processor, the first score and the second score into a combined score, generating, by the processor, a final score from the combined score, and outputting in real-time, by the processor, the final score to a display.

In an embodiment of the inventive method, the second score of the performance is based upon a score from a second judge having viewed a recording of the performance.

An embodiment of the inventive method further comprises verifying, by the processor, one of the first score, the second score and the combined score using the recording of the performance.

In an embodiment of the inventive method, the score from the first judge is created by the first judge using at least one scoring rubric corresponding to the performance, and wherein the step of generating a first score further comprises accessing, by the processor, the at least one scoring rubric stored in memory of the computing device and using the at least one scoring rubric to generate the first score.

In an embodiment of the inventive method, the at least one scoring rubric includes a plurality of criteria that include a plurality of elements and a difficulty level corresponding to each element.

In an embodiment of the inventive method, the step of generating a first score further comprises generating, by a processor of a computing device, a first score of the performance based upon a score from the first judge having viewed the performance live and having judged the performance using at least one scoring rubric corresponding to the performance.

In an embodiment of the inventive method, the step of generating, by the processor, a second score of the performance based upon a recording of the performance, further comprises receiving, by the processor, the recording, storing, by the processor, the recording in a memory of the computing device, receiving, by the processor, attribute data associated with the performance, time-stamping, by the processor, the attribute data, and generating, by the processor, the second score based upon the attribute data.

An embodiment of the inventive method further comprises determining, by the processor, whether additional attribute data of the performance is available, updating, by the processor, the final score when additional attribute data is available, outputting, by the processor, an updated final score, determining, by the processor, whether a competitor ranking has changed based upon the updated final score, adjusting, by the processor, the ranking of the competitor when that ranking has changed, and outputting in real-time, by the processor, the updated final score and changed ranking to a display.

In an embodiment of the inventive method the one scoring rubric corresponding to the performance used by the judge enables the judge to deduct points when judging the performance.

In accordance with an exemplary embodiment of the subject disclosure, there is provided a system for judging a performance (“the system”) comprising: a memory for storing data in an electronic form; a display; and a processor operatively in communication with the memory and the display, wherein the processor is configured to: receive in the memory a performance to be judged as video data; receive attribute data of the performance and record a time stamp of a time the attribute data is received; determine a performance score based on the received attribute data; output on the display, in real time, the performance score; update the performance score based on a subsequently received attribute data; and continuously output on the display in real time the updated performance score.

Another exemplary embodiment is directed to the system, wherein the processor is further configured to receive in memory audio data associated with the attribute data.

Another exemplary embodiment is directed to the system, wherein the processor is further configured to determine a confirmed performance score based on the attribute data, the video data, and the audio data.

Another exemplary embodiment is directed to the system, wherein the processor is further configured to determine a confirmed performance score based on the attribute data and the video data.

Another exemplary embodiment is directed to the system, wherein the processor is further configured determine a video data set of the video data associated with the attribute data and output a representative image of the video data set adjacent the attribute data associated with the video data set.

Another exemplary embodiment is directed to the system, wherein the processor is further configured determine a video data set of the video data associated with the attribute data and output a representative image of the video data set adjacent the attribute data associated with the video data set, and the time stamp of the attribute data.

Another exemplary embodiment is directed to the system, wherein the processor is configured to receive a plurality of attribute data.

Another exemplary embodiment is directed to the system, wherein the plurality of attribute data comprises difficulty attribute data and deduction attribute data.

Another exemplary embodiment is directed to a method of producing a performance event comprising: assigning a judge to judge an attribute of a performance and inputting the attribute data of the attribute into the system described above, outputting on the display in real time the updated performance score; and modifying a placement based on the real time updated performance score.

Another exemplary embodiment is directed to the method of producing a performance event, further comprising: assigning a first judge to judge a difficulty attribute of the performance; and assigning a second judge to judge a deduction attribute of the performance.

Another exemplary embodiment is directed to the method of producing a performance event, further comprising: assigning a single judge to judge a difficulty attribute of the performance; and assigning a single judge to judge a deduction attribute of the performance.

### BRIEF DESCRIPTION OF THE SEVERAL VIEWS OF THE DRAWINGS

The foregoing summary, as well as the following detailed description of the exemplary embodiments of the subject disclosure will be better understood when read in conjunction with the appended drawings. For the purpose of illustrating the invention, there are shown in the drawings exemplary embodiments. It should be understood, however, that the subject disclosure is not limited to the precise arrangements and instrumentalities shown.

In the drawings:

FIG. 1 is a schematic view of a competition according to an exemplary embodiment of the disclosure.

FIG. 2 depicts a series of steps according to an exemplary embodiment of the disclosure.

FIG. 3 depicts a series of steps according to another exemplary embodiment of the disclosure.

FIG. 4 depicts a series of steps according to yet another exemplary embodiment of the disclosure.

FIG. 5 depicts a series of steps according to yet another exemplary embodiment of the disclosure.

FIGS. 6A-6N illustrate exemplary GUIs applicable to embodiments of the disclosure.

FIG. 7A-1 illustrates a first part of a first exemplary scoring rubric applicable to embodiments of the disclosure.

FIG. 7A-2 illustrates a second part of a first exemplary scoring rubric applicable to embodiments of the disclosure.

FIG. 7A-3 illustrates a third part of a first exemplary scoring rubric applicable to embodiments of the disclosure.

FIG. 7B-1 illustrates a first part of a second exemplary scoring rubric applicable to embodiments of the disclosure.

FIG. 7B-2 illustrates a second part of a second exemplary scoring rubric applicable to embodiments of the disclosure.

FIG. 7C-1 illustrates a first part of a third exemplary scoring rubric applicable to embodiments of the disclosure.

FIG. 7C-2 illustrates a second part of a third exemplary scoring rubric applicable to embodiments of the disclosure.

FIG. 7D-1 illustrates a first part of a fourth exemplary scoring rubric applicable to embodiments of the disclosure.

FIG. 7D-2 illustrates a second part of a fourth exemplary scoring rubric applicable to embodiments of the disclosure.

FIG. 7D-3 illustrates a third part of a fourth exemplary scoring rubric applicable to embodiments of the disclosure.

FIG. 7E-1 illustrates a first part of a fifth exemplary scoring rubric applicable to embodiments of the disclosure.

FIG. 7E-2 illustrates a second part of a fifth exemplary scoring rubric applicable to embodiments of the disclosure.

FIG. 7F-1 illustrates a first part of a sixth exemplary scoring rubric applicable to embodiments of the disclosure.

FIG. 7F-2 illustrates a second part of a sixth exemplary scoring rubric applicable to embodiments of the disclosure.

FIG. 7G illustrates a seventh exemplary scoring rubric applicable to embodiments of the disclosure.

FIG. 7H-1 illustrates a first part of an eighth exemplary scoring rubric applicable to embodiments of the disclosure.

FIG. 7H-2 illustrates a second part of an eighth exemplary scoring rubric applicable to embodiments of the disclosure.

FIG. 7H-3 illustrates a third part of an eighth exemplary scoring rubric applicable to embodiments of the disclosure.

FIG. 7H-4 illustrates a fourth part of an eighth exemplary scoring rubric applicable to embodiments of the disclosure.

FIG. 7H-5 illustrates a fifth part of an eighth exemplary scoring rubric applicable to embodiments of the disclosure.

FIG. 7I-1 illustrates a first part of a ninth exemplary scoring rubric applicable to embodiments of the disclosure.

FIG. 7I-2 illustrates a second part of a ninth exemplary scoring rubric applicable to embodiments of the disclosure.

FIG. 7I-3 illustrates a third part of a ninth exemplary scoring rubric applicable to embodiments of the disclosure.

FIG. 8 depicts a function diagram of aspects of embodiments of the disclosure.

FIG. 9 depicts a scoring workflow diagram of embodiments of the disclosure.

FIG. 10 depicts aspects of administrator or judge tabulation print outs for embodiments of the disclosure.

FIG. 11 depicts a flow diagram of data entry workflow applicable to embodiments of the disclosure.

### DETAILED DESCRIPTION

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not necessarily drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, based at least in part upon the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

Exemplary embodiments of the present disclosure will be described more thoroughly from now on regarding the accompanying drawings. Like numerals represent like elements throughout the several figures, and in which example embodiments are shown. However, embodiments of the claims may be embodied in many different forms and should not be construed as limited to the images set forth herein. The examples set forth herein are non-limiting examples and are merely examples, among other possible examples.

As stated above, there are challenges in providing efficient, reliable, uniform and accurate judging of events such as cheerleading, gymnastic competitions, figure skating competitions, diving competitions and other competitions that involve judging a performance. While these competitions have scoring rubrics and guidelines, the judges need to be able to accurately evaluate the performance. The evaluation should be uniform and accurate to increase fairness of the competition. The judging results should also stand-up to scrutiny and be capable of being calculated quickly. Additionally, the judging process should be efficient in the number of judges needed to generate this outcome.

For explanation purposes, exemplary embodiments of this disclosure are described using a cheerleading team competition event. It will be obvious to a person of skill in the art from the disclosure provided herein that a cheerleading event is merely an illustrative, non-limiting example of the present invention, and that other events are contemplated by, and within the scope and spirit of the present disclosure. The disclosure may also be applied to other types of team and individual competitions, such as gymnastics, figure skating, diving, judo, boxing, synchronized swimming, ice dance, wrestling or any other event or performance that is evaluated by judges.

One exemplary embodiment of the disclosure is directed to a method that permits accurate, quick and defensible judging results using a panel of 3-4 judges. Thus, this disclosure is directed to a system and method that more closely approximates objective judging—attempting to reduce or eliminate judging subjectivity and inaccuracy. A first judge evaluates a performance for a difficulty level of each stunt and tumble. A second judge evaluates one or more techniques for the entire routine and a third judge evaluates the routine for deductions, drops and bobbles. Any number of additional judges may be assigned to one of the above-identified tasks or other tasks routinely judged in various competitions.

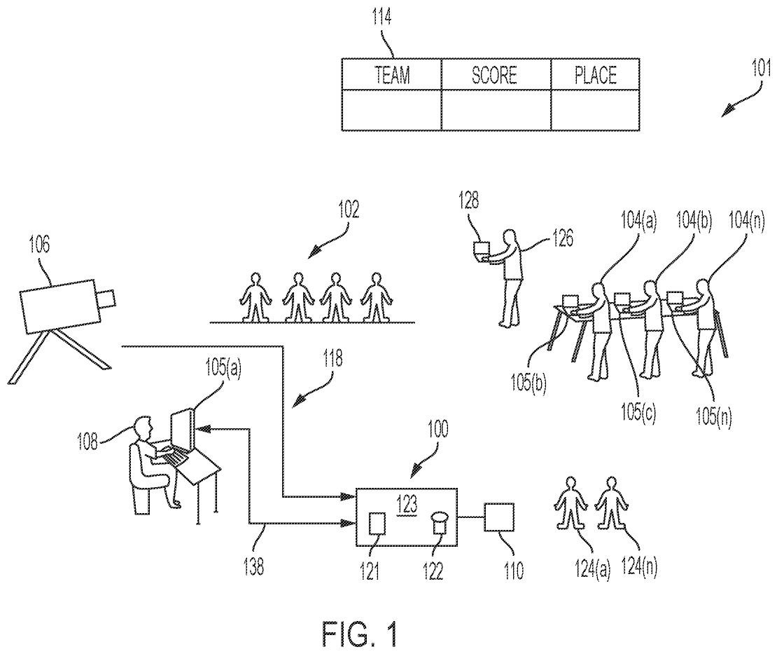

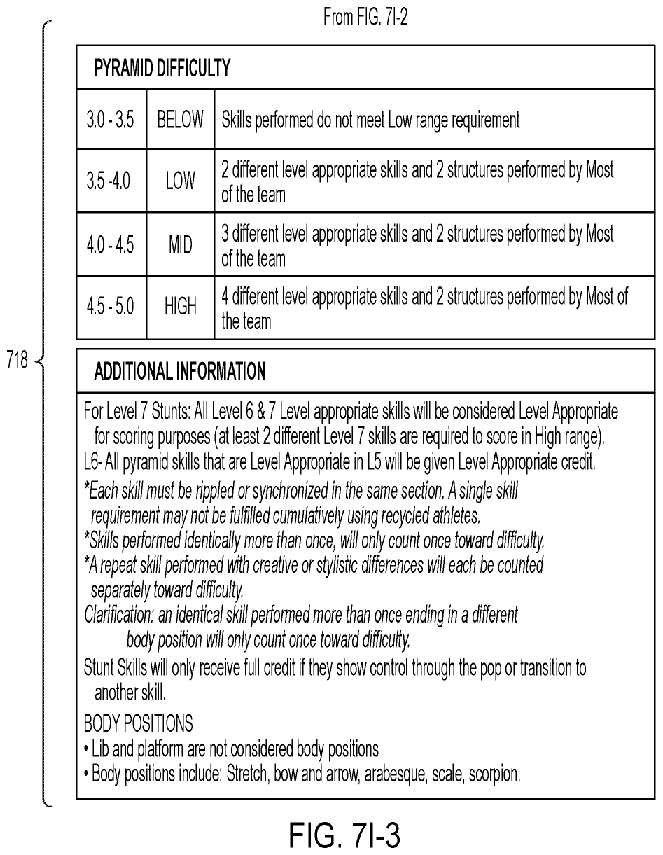

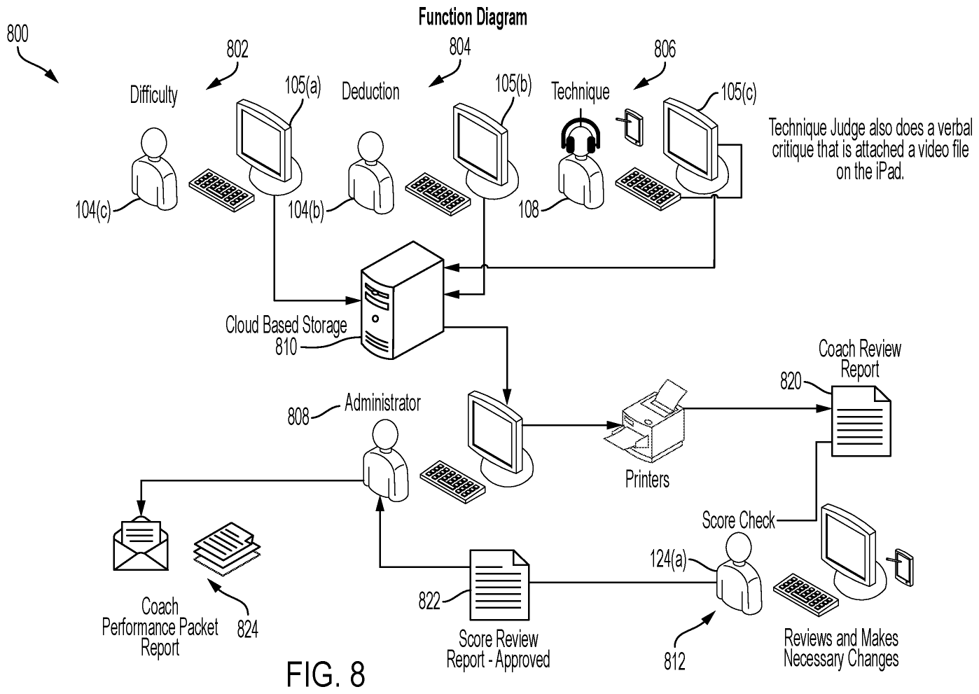

Referring to FIGS. 1 and 8, a system and method in accordance with embodiments of the present disclosure will be discussed in greater detail. The inventive system 100 comprises a computer 123 having a processor 121, a non-transitory computer-readable medium 122 such as, by way of non-limiting example, a temporary and/or permanent memory, having instructions stored thereon, and a display 110. The system 100 provides for electronic, interactive judging that enables efficient and seamless judging of a performance by one or more judges, and for generating real-time scoring of the performance. FIG. 1 illustrates a competition environment 101 in which the system 100 can be used in accordance with the present disclosure. While FIG. 1 illustrates various systems and components contained in the competition environment 101, FIG. 1 illustrates one example of the competition environment 101 of the present disclosure, and additional components can be added and existing systems and components can be removed.

The memory 122 may include electronic storage registers, ROM, RAM, EEPROM, non-transitory electronic storage medium, volatile memory or non-volatile electronic storage media, disk drives, permanent and removable storage media, and/or other suitable computer memory that stores data in electronic form. The display can be any now known or hereafter developed output device that presents information that a user can view. The displayed information may be text data, image data, video data, audio data or any combination thereof. The processor 121 is operatively in communication with memory 122 and the display 110.

The inventive method is carried out by the processor 121 access to and execution of one or more instructions stored as code in memory 122.

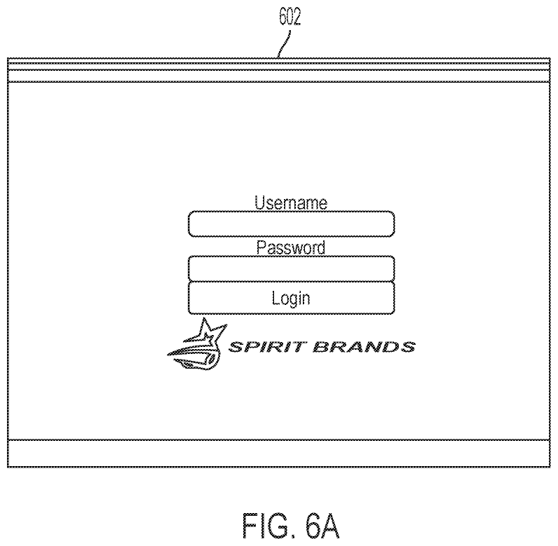

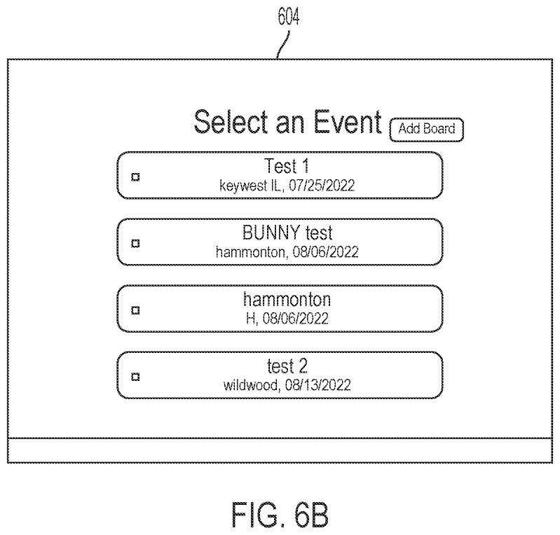

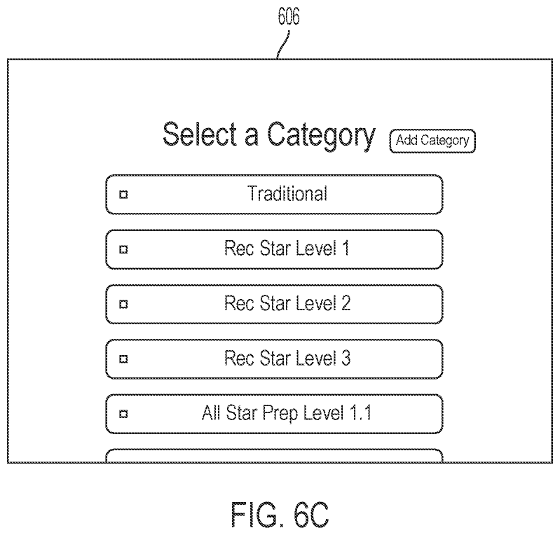

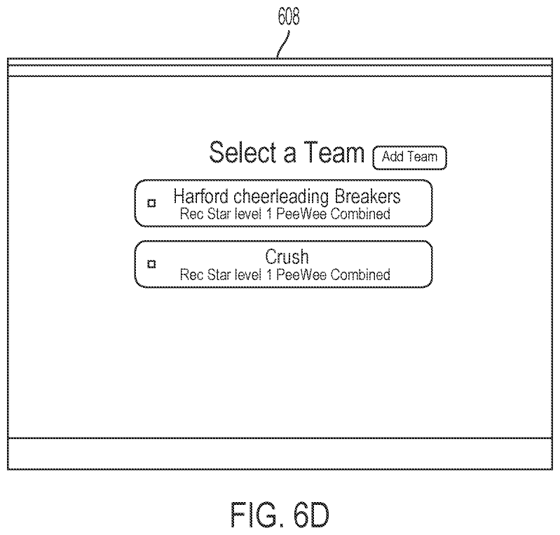

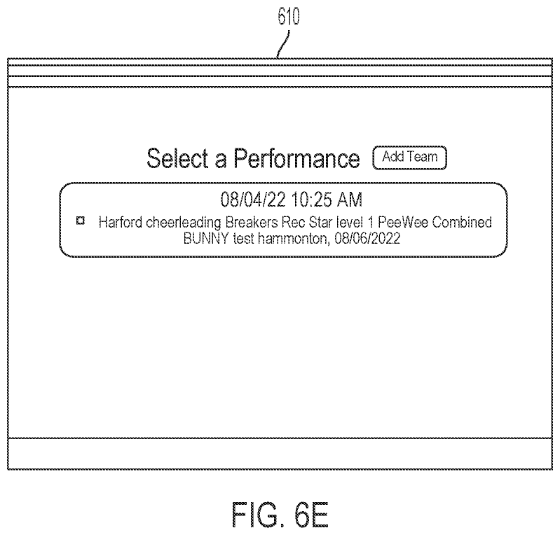

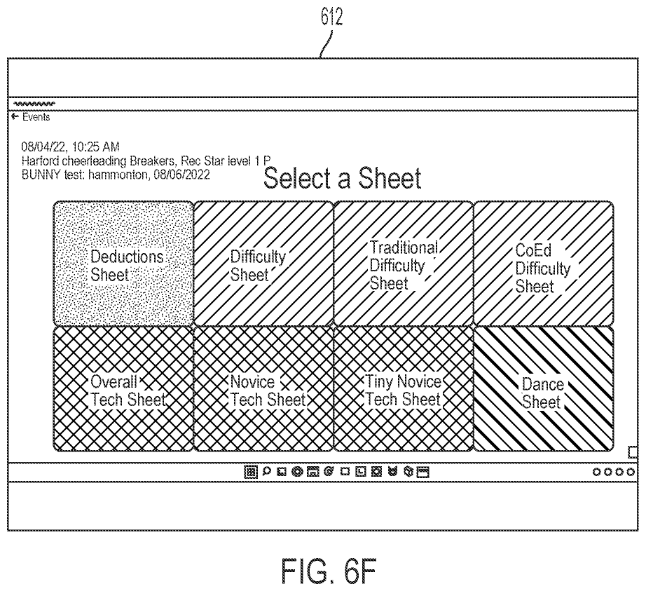

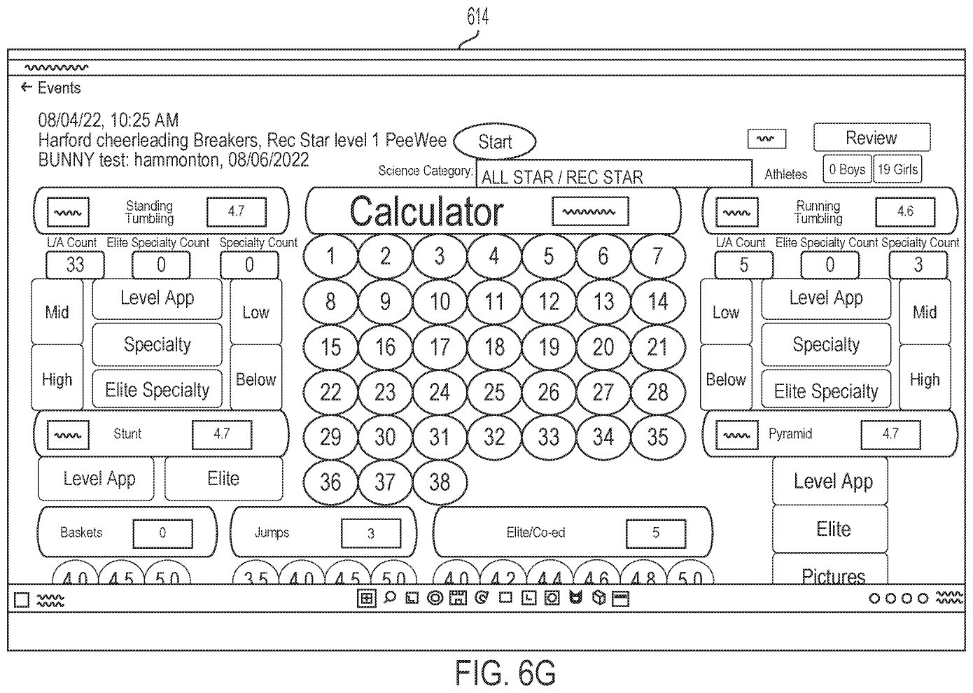

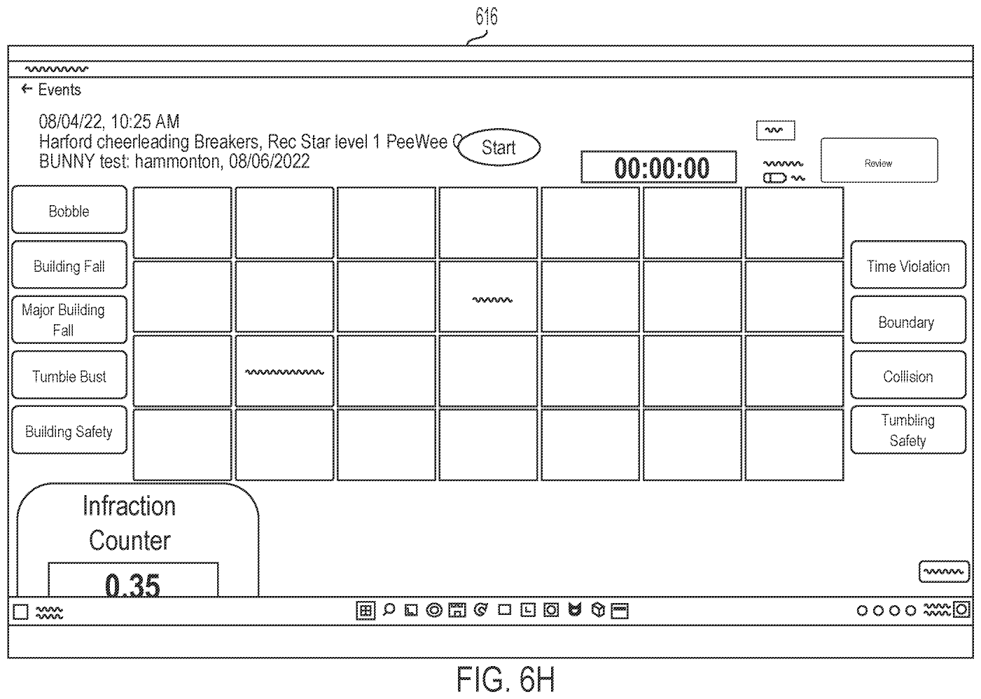

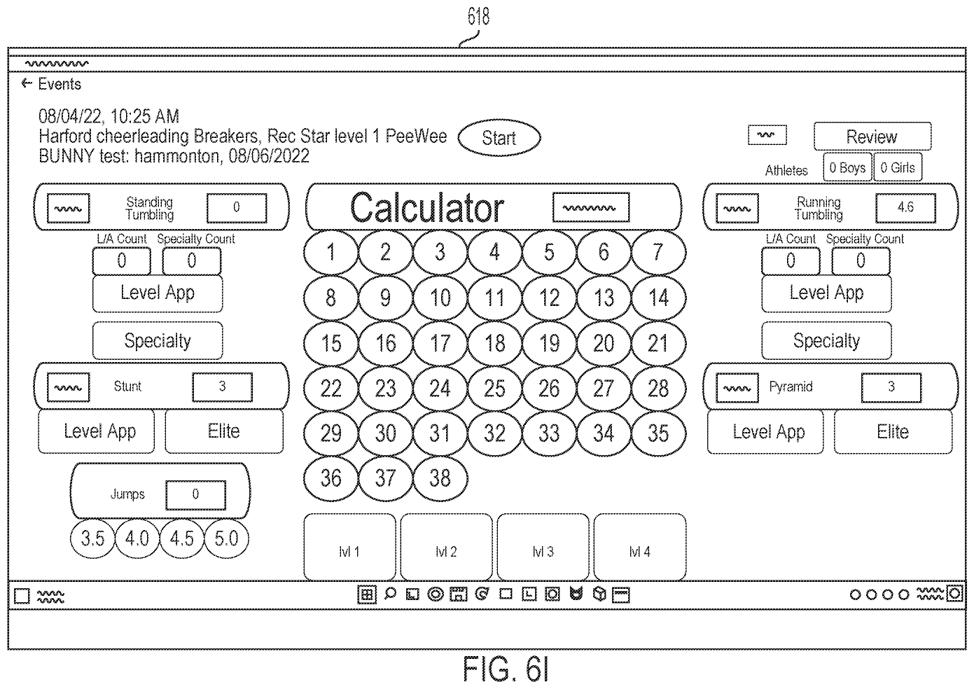

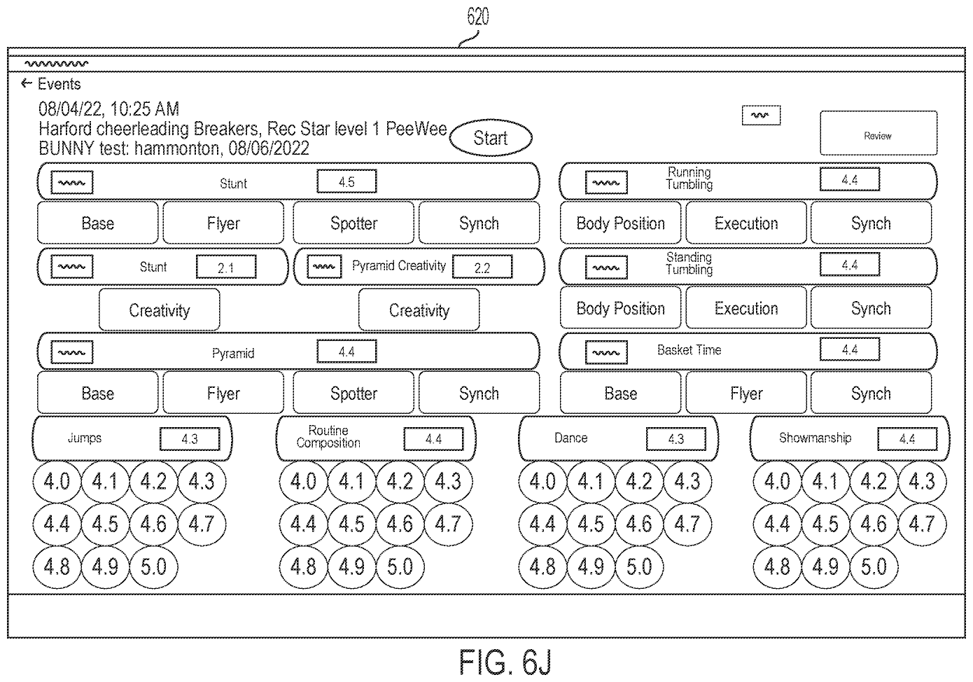

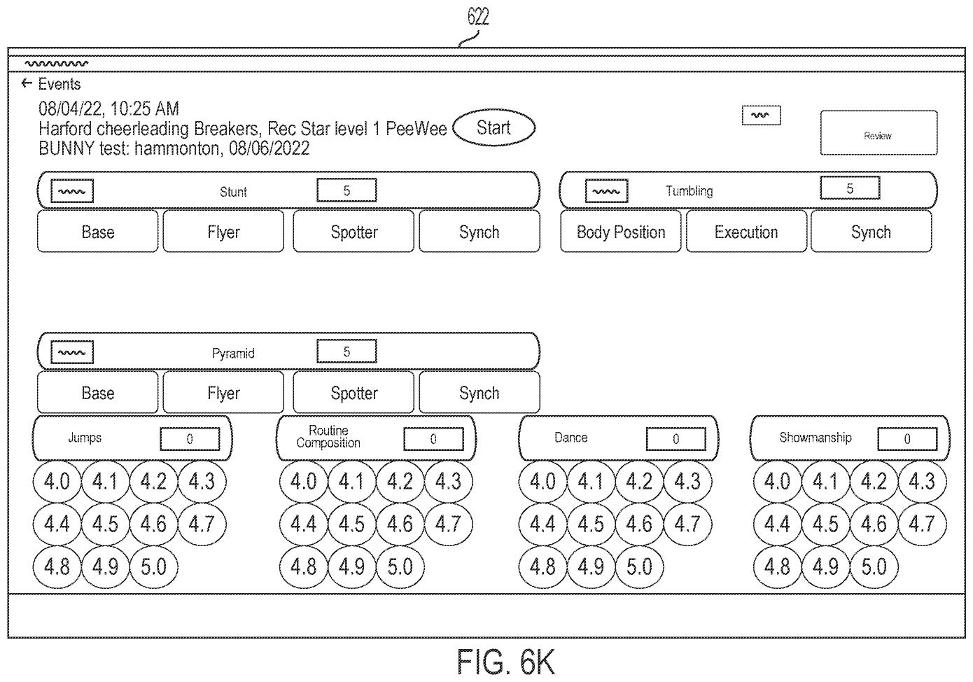

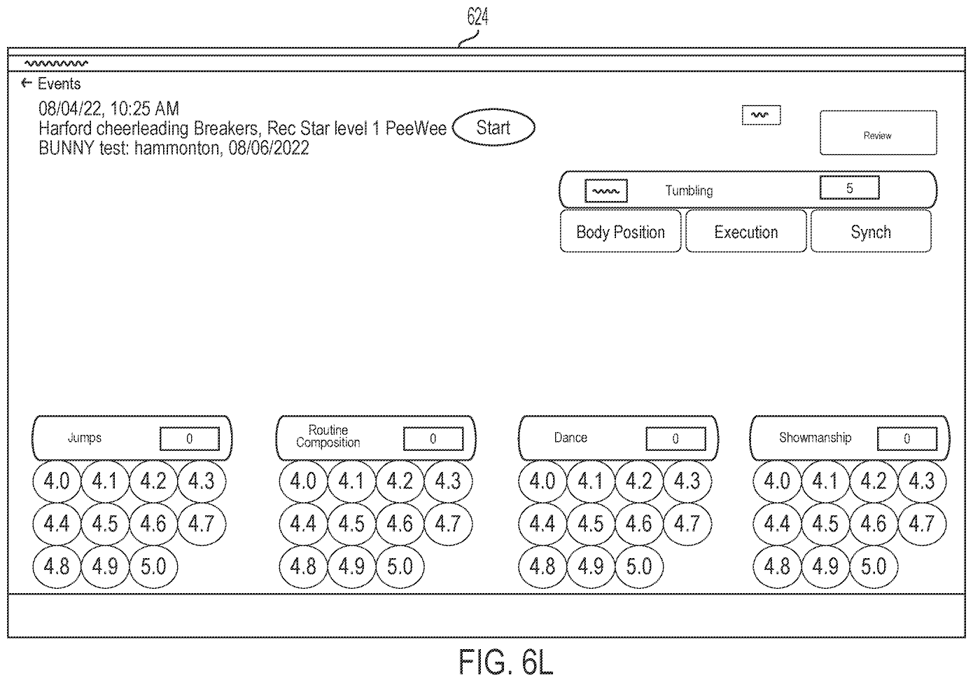

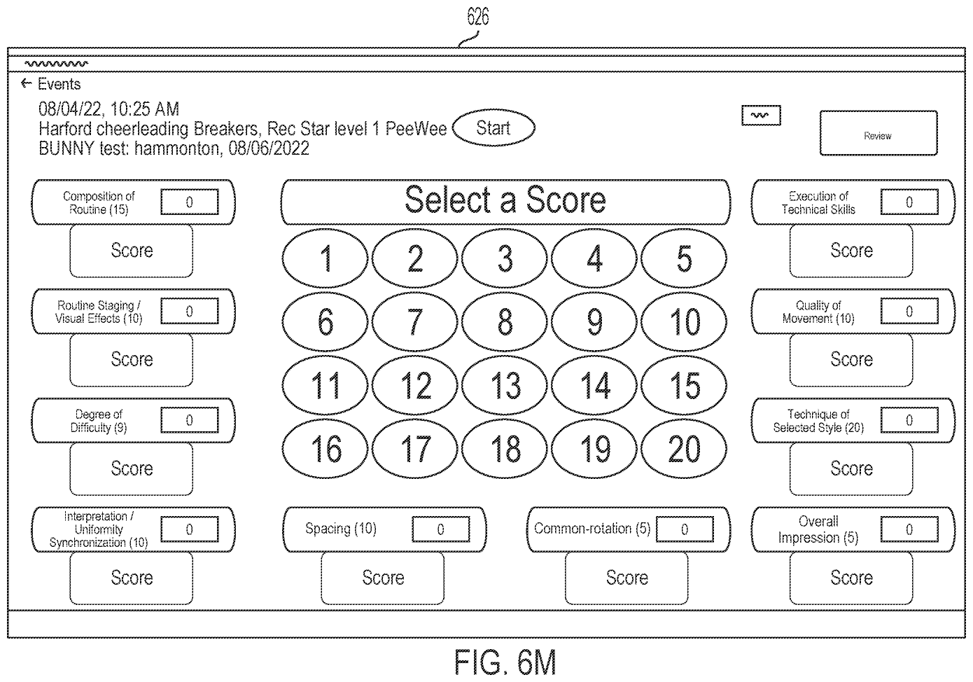

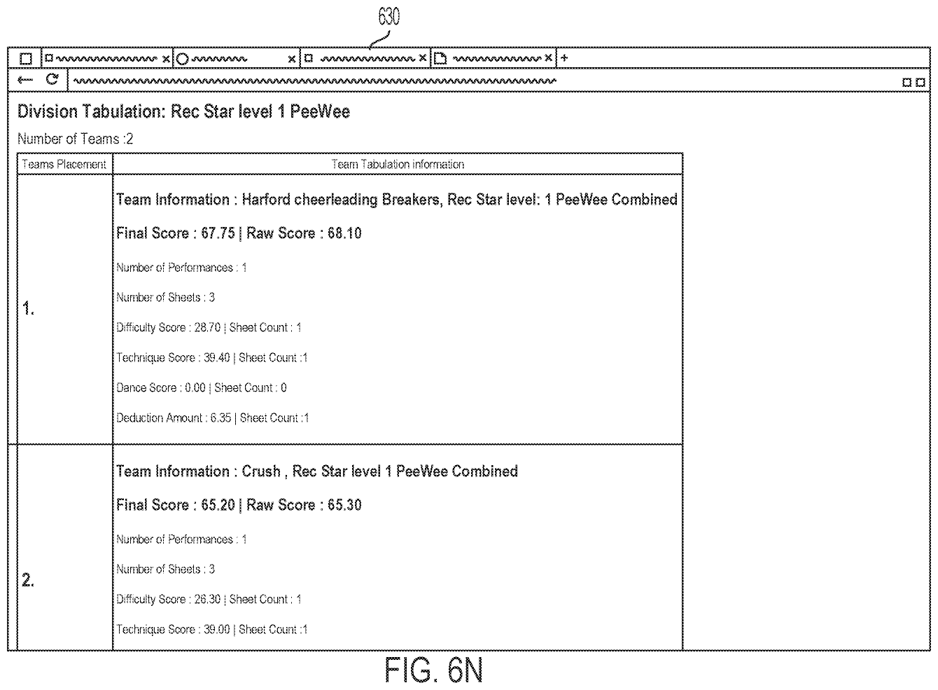

The competition environment 101 may include or more judges 105(a) . . . (n) using one or more judge computing devices 104(a) . . . (n). A plurality of graphical user interfaces (GUIs) may be displayed on a judge computing device 104, providing an interface via which a judge may enter data, information, audio and non-audio comments, and other input provided by a judge 105 while judging a live or recorded performance. For example, FIG. 6A depicts a login screen 602 via which a judge may enter login credentials and access further GUI screens and functionality via which the judge may view and evaluate a performance. A judge 105 may select an event to judge using an event selection screen 604, as depicted in FIG. 6B. A judge 105 may select a category of performance to judge using a select a category screen 606, as depicted in FIG. 6C. A judge 105 may select a team to judge using a select a team screen 608, as depicted in FIG. 6D. A judge 105 may select a performance to judge using a select a performance screen 610, as depicted in FIG. 6E. A judge 105 may select a sheet for the criteria of the category of the performance being judged using a select a sheet screen 612, as depicted in FIG. 6F. A plurality of views of the GUI via which each judge 105 enters their judging selections are depicted in FIGS. 6G-6M, designated as 614, 616, 618, 620, 622, 624 and 626. FIG. 6N depicts an output of a result of a performance judged by at least one judge 105, including information such as, by way of non-limiting example, team name, final score, raw score, and other information and data about a specific performance.

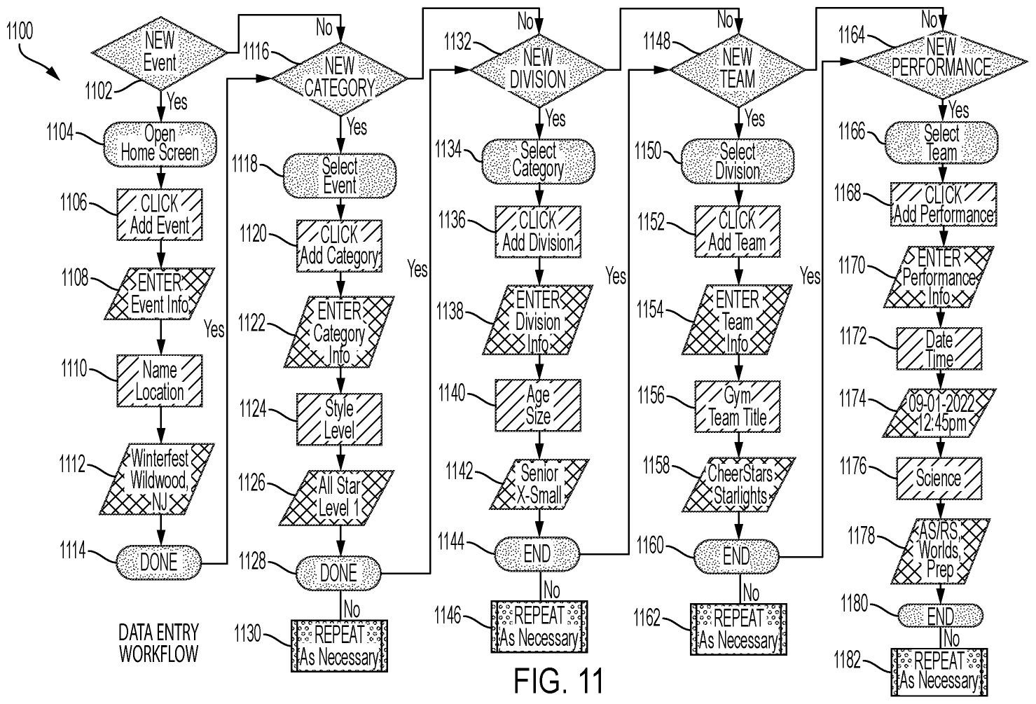

Referring next to FIG. 11, a flow diagram 1100 for data entry workflow using one or more of the GUI depicted in FIGS. 6A-6N is depicted and will now be described in greater detail. At step 1102 it is determined whether a new event is to be judged. The terms event and performance are used interchangeably herein unless otherwise indicated to the contrary. If yes, a home screen is opened at step 1104, and a judge can add an event at step 1106. At step 1108 the judge enters information about the event, including a name and location at steps 1110 and 1112. This part of the workflow is done at step 1114. If a new category is required to be judged, as depicted at step 1116, the judge can select an event at step 1118, and add a category at step 1120. At step 1122 the judge can enter category information, and style and level for the performance at step 1124, including a specific style, e.g., All Star, and level, e.g., Level 1, at step 1126. This part of the workflow is done at step 1128, but can be repeated as necessary at step 1130. If a new division is required to be judged, as depicted at step 1132, the judge can select a category at step 1134, and add a division at step 1136. At step 1138 the judge can enter division information including age and size at step 1140, including specific age, e.g., senior, and size, e.g., extra-small, at step 1142. This part of the workflow is done at step 1144, but can be repeated as necessary at step 1146. If a new team is required to be judged, as depicted at step 1148, the judge can select a division at step 1150, and add a team at step 1152. At step 1154 the judge can enter team information including gym and team title at step 1156, including specific gym, e.g., CheerStars, and team title, e.g., Starlights, at step 1158. This part of the workflow is done at step 1160, but can be repeated as necessary at step 1162. If a new performance is required to be judged, as depicted at step 1164, the judge can select a team at step 1166, and add a performance at step 1168. At step 1170 the judge can enter performance information including date and time at step 1172, including specific a specific date and time at step 1174. At step 1176 and 1178 a judge can enter data relating to other aspects of the performance, as indicated in FIG. 11. This part of the workflow is done at step 1180, but can be repeated as necessary at step 1182.

In embodiments, the system 100 is configured to provide an interactive and real-time judging platform that enables one or more judges to efficiently and seamlessly evaluate and score events in the competition environment 101. The inventive system 100 further enables real-time generation and display of a score of a performance, where the score may be that of an individual judge, one or more judges separately, or an aggregate score of one or more judges. The inventive disclosure is directed to accomplishing this in a way that minimizes or reduces subjectivity of one or more judges and that further enables real-time generating of a score of the performance.

The inventive discourse is further directed to a method and system that improves the process of judging a performance by enabling real-time generation and display of a score of a performance by incorporating multiple judges viewing a performance from multiple perspectives and with a plurality of distinct responsibilities for viewing and judging the performance. The inventive disclosure further improves the process of judging a performance by enabling real-time generation and display of a score of a performance by generating a plurality of scores from a plurality of judges viewing a live version of the performance. The inventive disclosure still further improves the process of judging a performance by enabling real-time generation and display of a score of a performance by a reviewing a recording of the performance by a technical judge and annotating the recording of the performance with comments, data, information, etc. from the technical judge. The inventive disclosure still further improves the process of judging a performance by enabling real-time generation and display of a score of a performance by generating a combined score from a combination of the scores from the judges watching the live and recorded performance. The system and method of the present disclosure further improves the process of judging a performance by enabling real-time generation and display of a score of a performance by enabling additional review of the performance after a combined score has been generated, and outputting the final score in real-time.

The system and method of the present disclosure further improves the process of judging a performance by enabling real-time generation and display of a score of a performance by generating a raw score for each judge viewing the live performance and a recording of the performance, generating a first performance score and a second performance score, combining the first and second performance scores into a composite or final score, using a recording of the performance to verify the composite or final score, and outputting the composite or final score in real-time.

The system and method of the present disclosure further improves the process of judging a performance by enabling real-time generation and display of a score of a performance by receiving and recording a performance, receiving and time-stamping attribute data from one or more judges, determining a performance scored based upon the attribute data, outputting the performance score in real-time, updating the performance score when additional attribute data is available, continuously updating the performance score, determining a confirmed performance score, determining whether a competitor's ranking has changed based upon the confirmed performance score, adjusting the competitor ranking if necessary, and outputting the score and ranking in real-time.

The system and method of the present disclosure further improves the process of judging a performance by enabling real-time generation and display of a score of a performance by accessing one or more judge's evaluations of a performance, generating a first performance scored based upon the one or more judge's evaluations, generating a second performance score based upon a recording of the performance, combining the first and second performance scores, creating a final score, and outputting the final score in real-time.

In embodiments, the system 100, the processor 121 is configured to, when executing one or more instructions stored in memory, access memory 122 to access, retrieve or playback a video recording or a performance to be judged. The video may have associated attribute data of the performance and one or more time stamps associated with the attribute data. The processor 121 is further configured to, when executing one or more instructions stored in memory, create a performance score from at least a first score from at least one judge, and at least a second score based upon a recording of the performance. At least one of the first score and second score may be at least in part based upon the attribute data. The processor 121 is yet further configured to, when executing one or more instructions stored in memory, output to the display 110 and additionally or alternatively to a scoreboard 114, in real-time, a composite or final performance score. The processor 121 is yet further configured to, when executing one or more instructions stored in memory, update the composite or final performance score based on a subsequently received attribute data, and continuously output on the display 110 and/or scoreboard 114 in real-time, the updated performance score. The attribute data can be any data representative of an attribute of the performance being judged, for example, a performance that is to be judged live. Exemplary attribute data can be by way of non-limiting example, stunt data, pyramid data, stunt quality data, standing tumbling data, running tumbling data, jumps data, routine composition data, performance data and/or dance data.

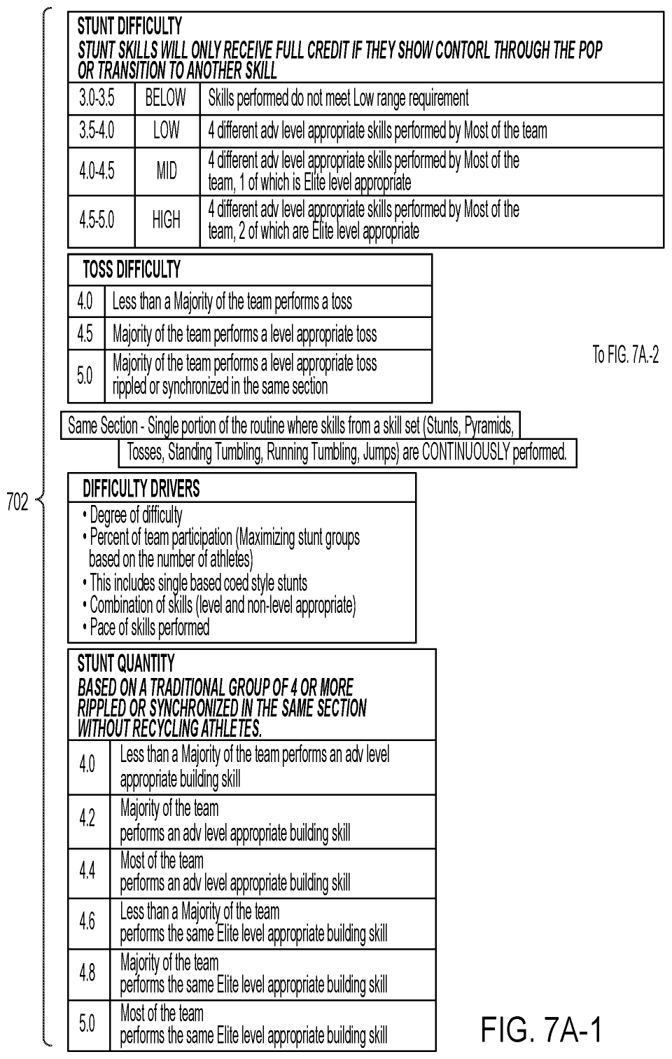

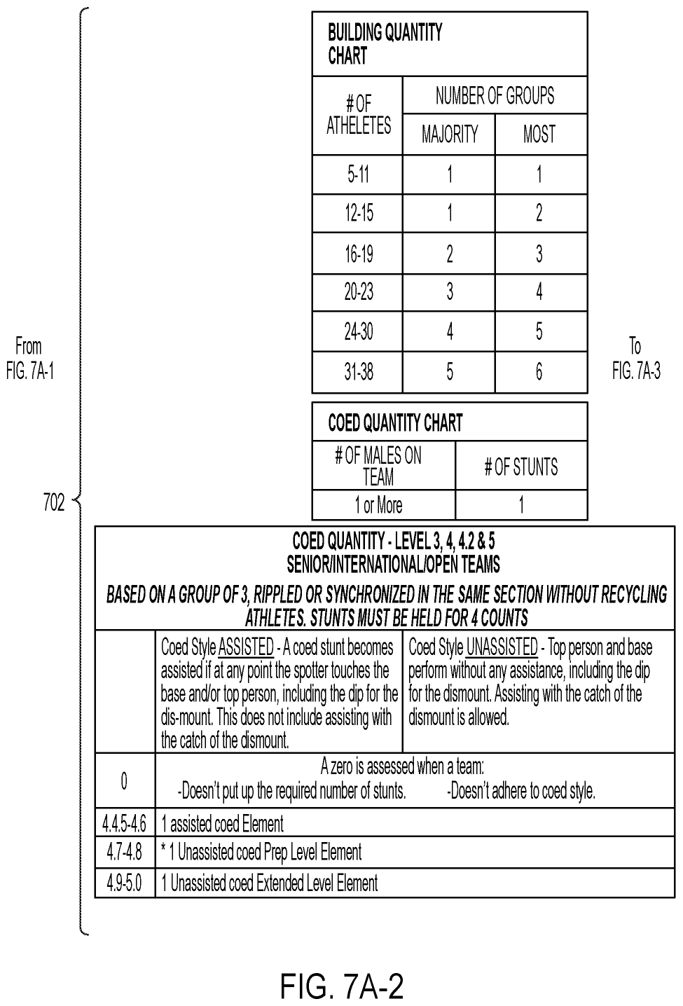

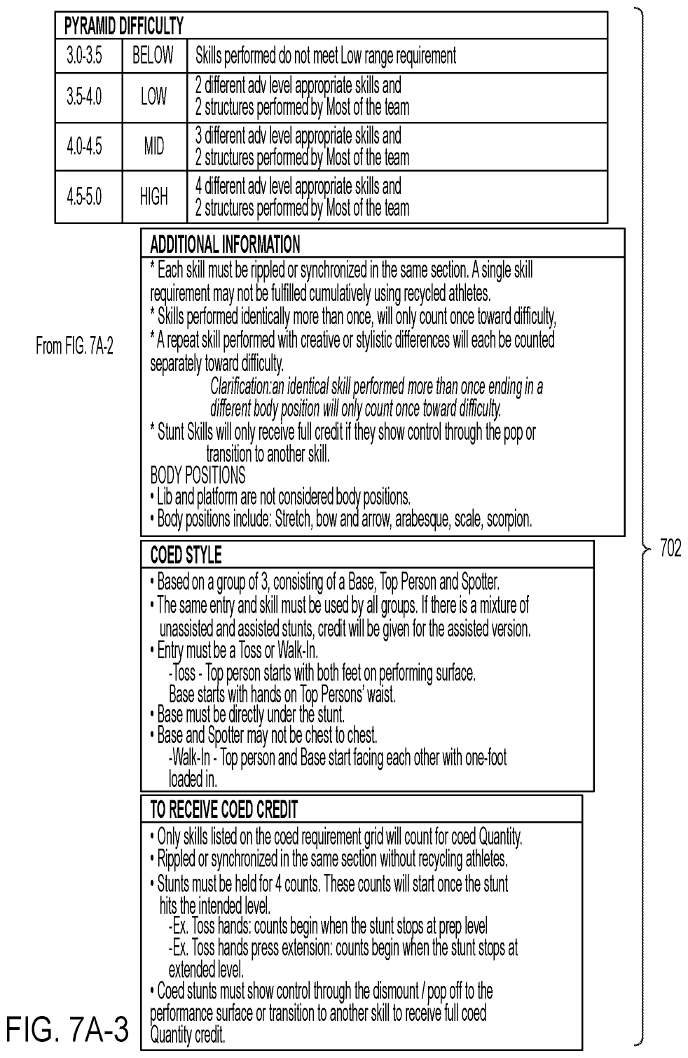

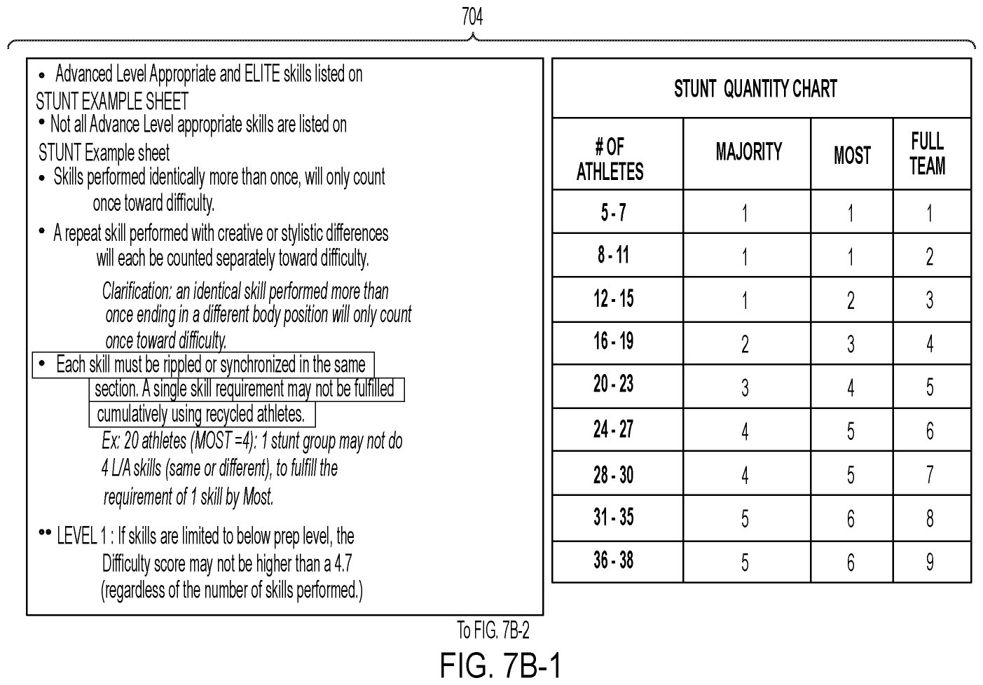

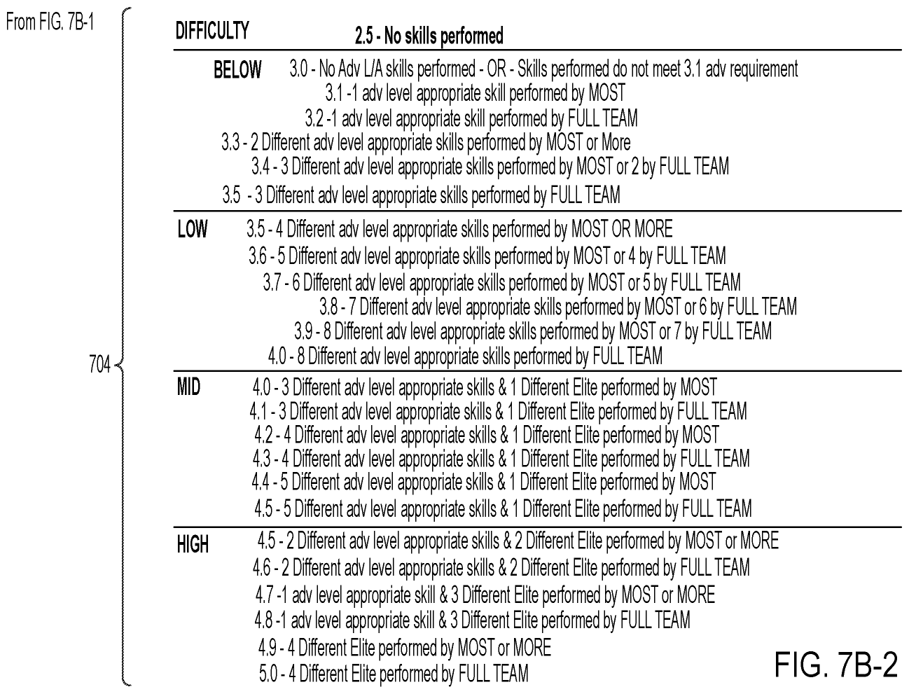

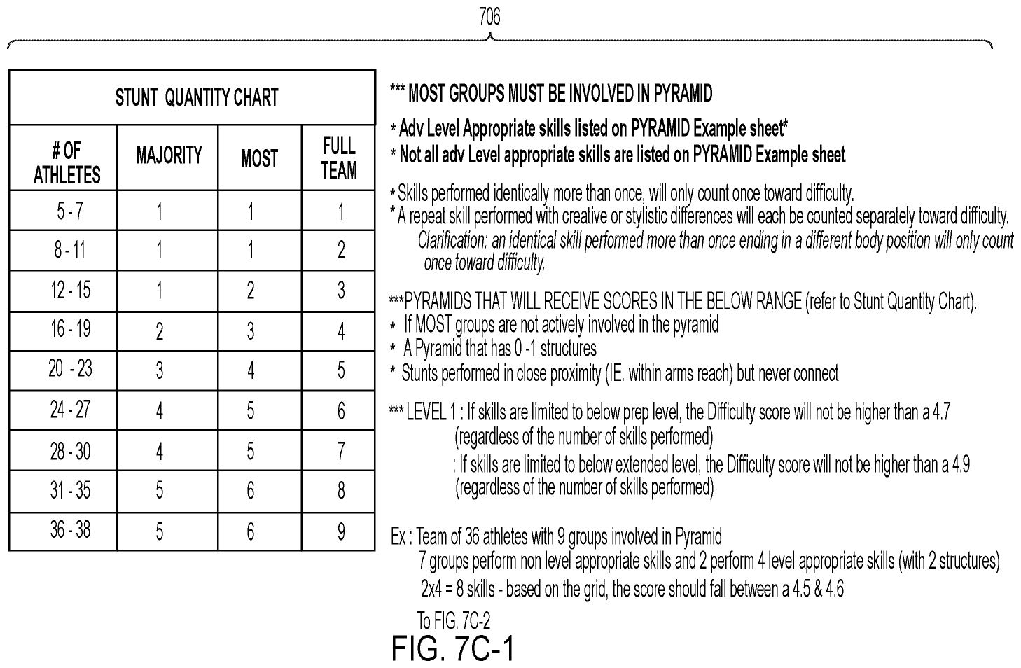

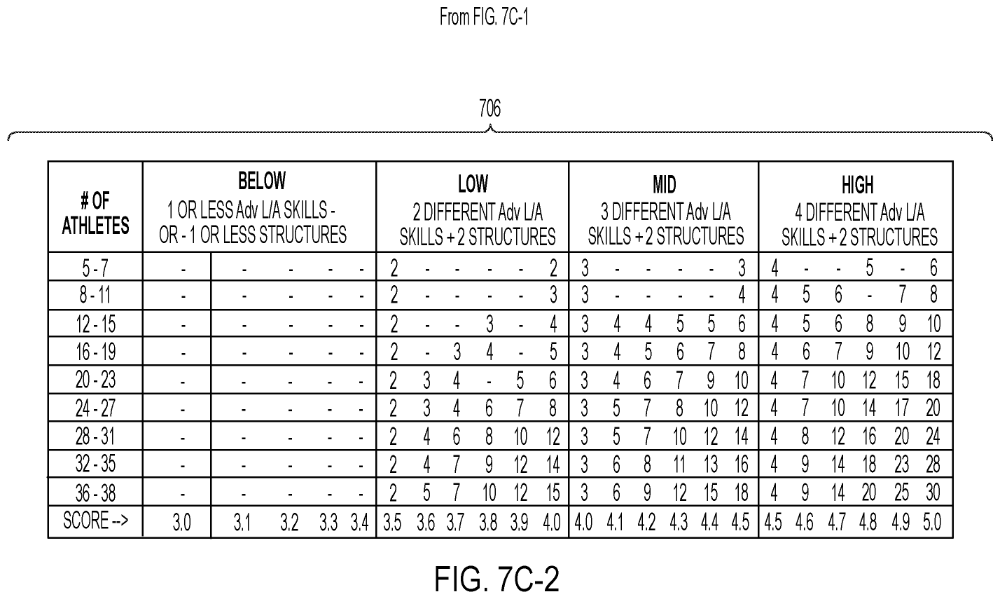

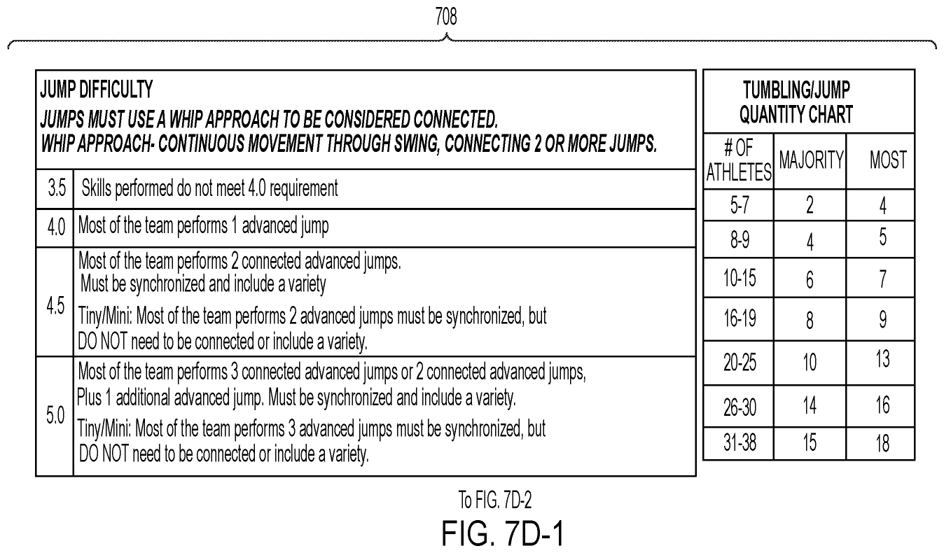

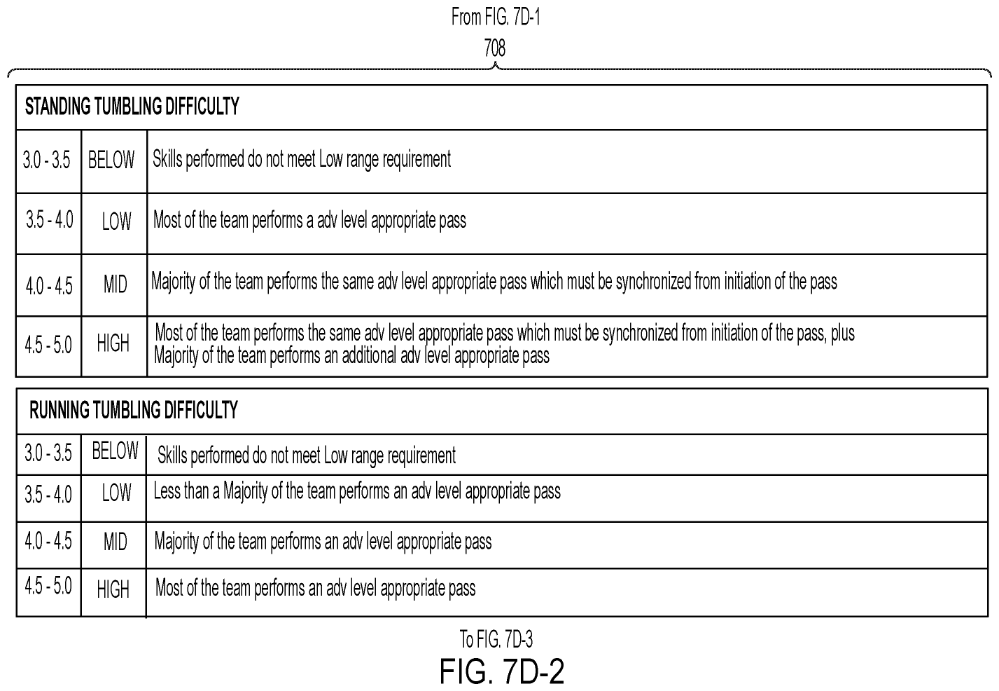

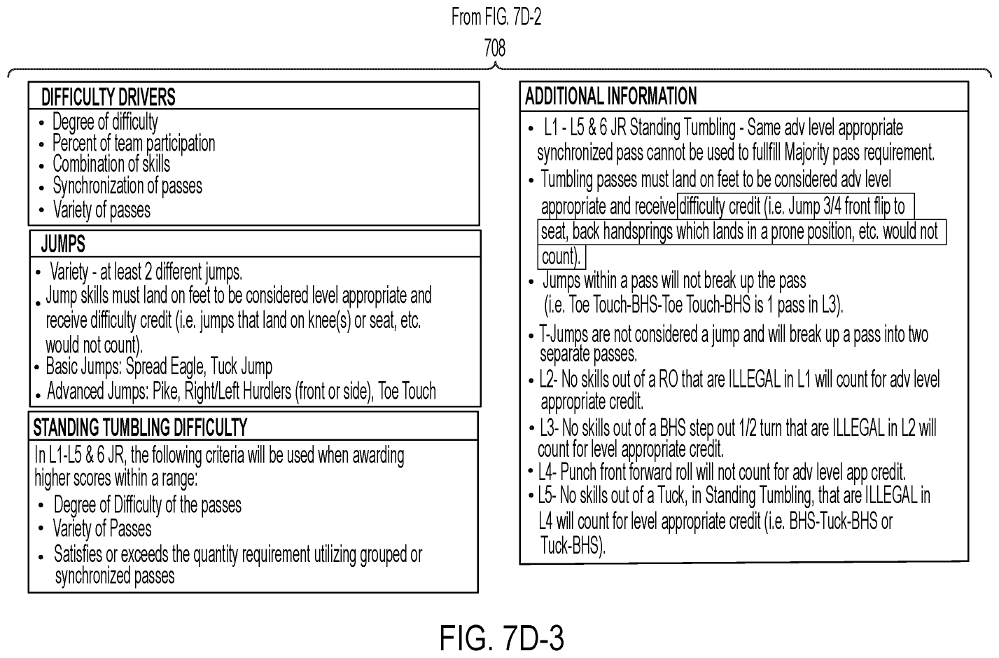

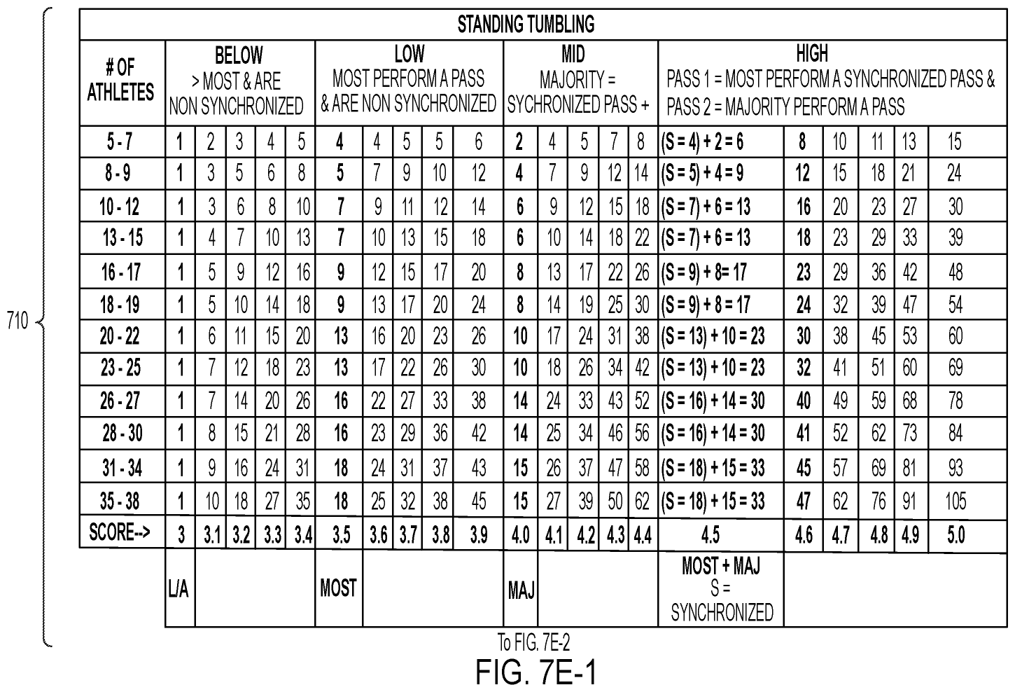

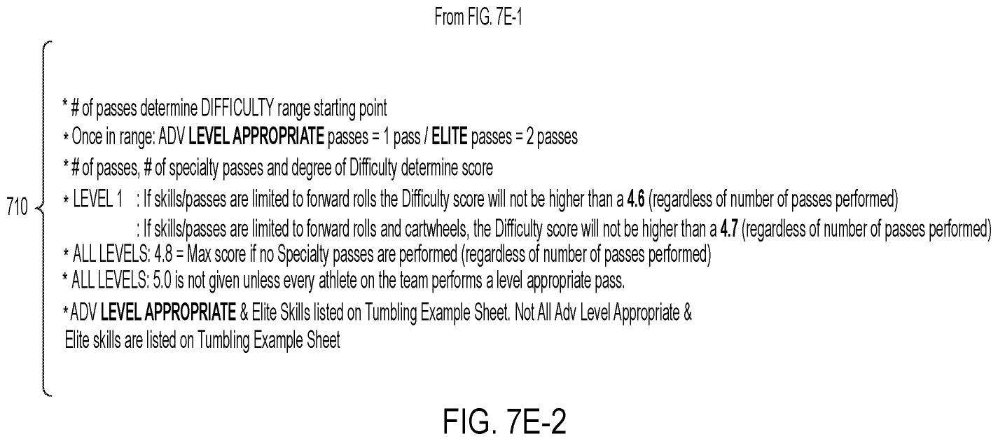

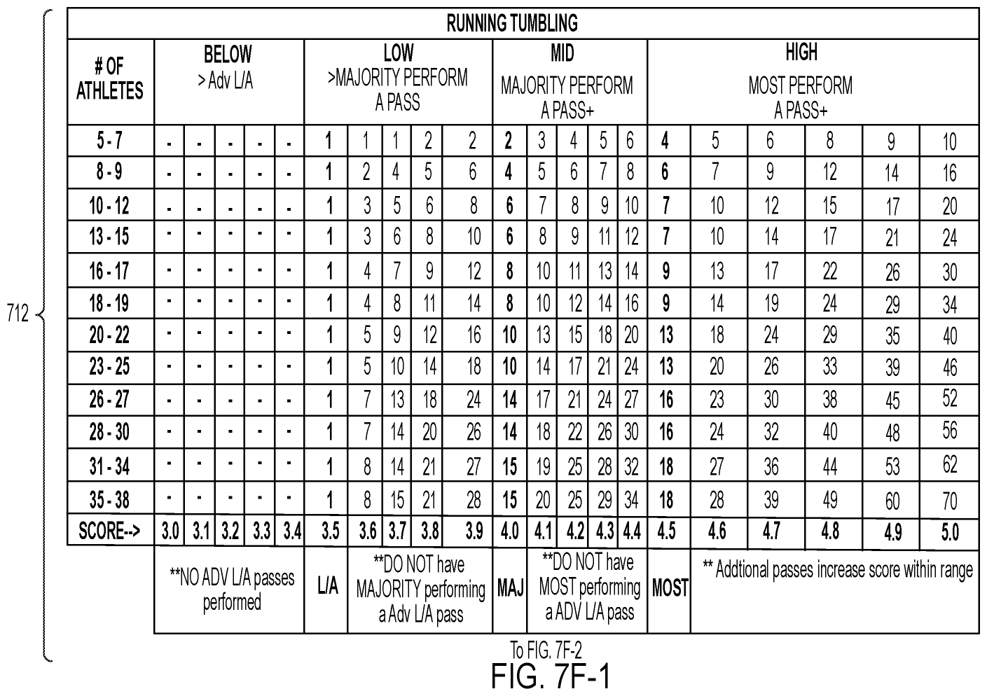

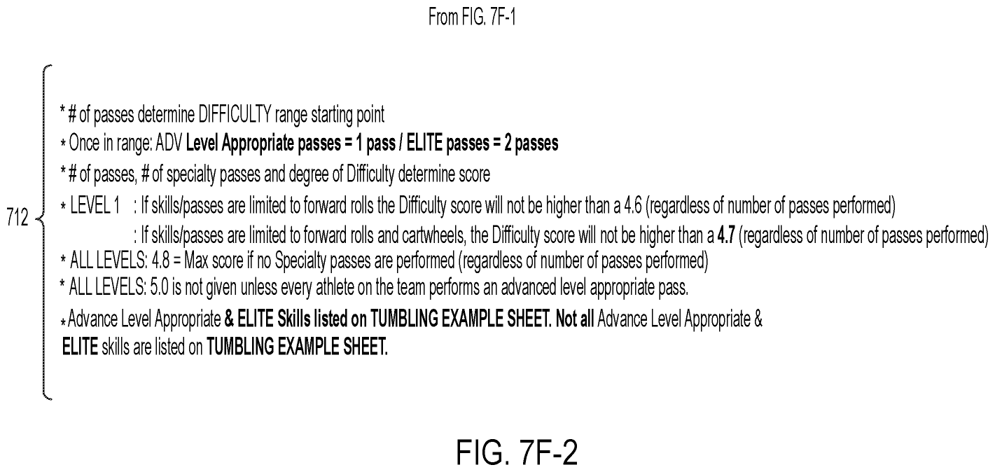

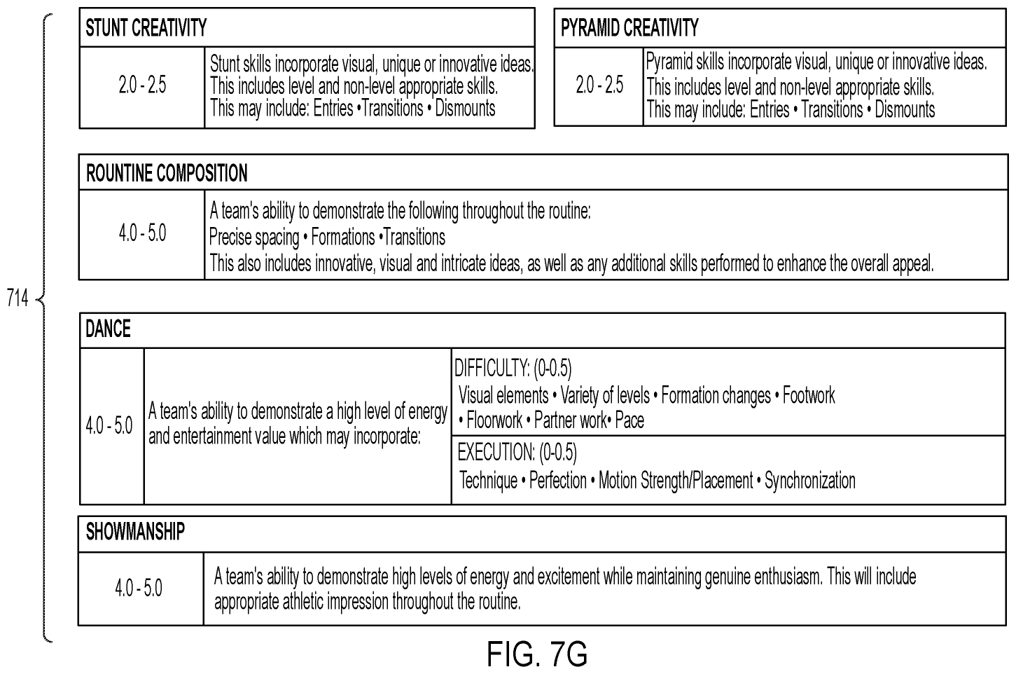

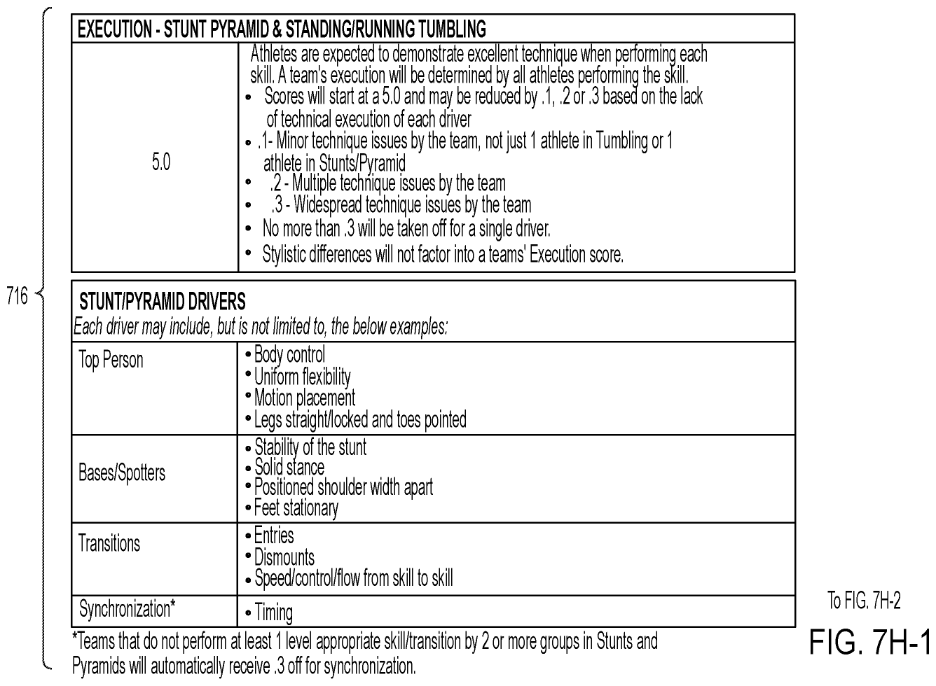

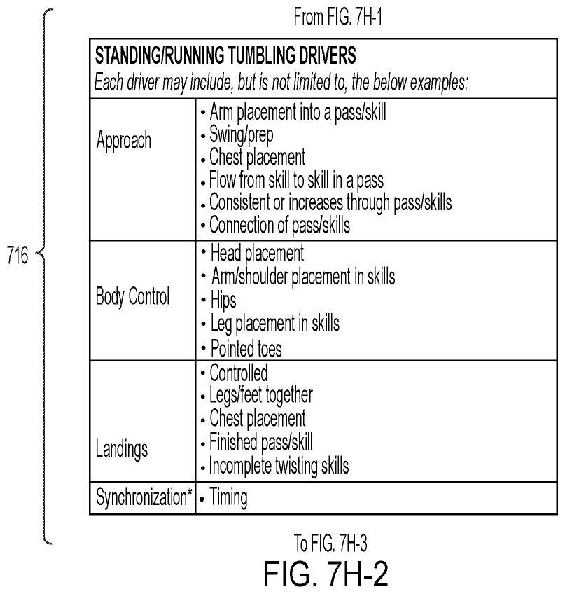

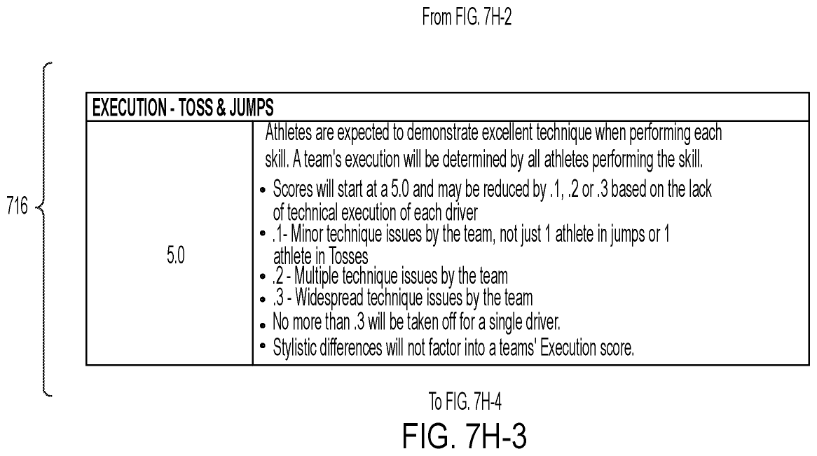

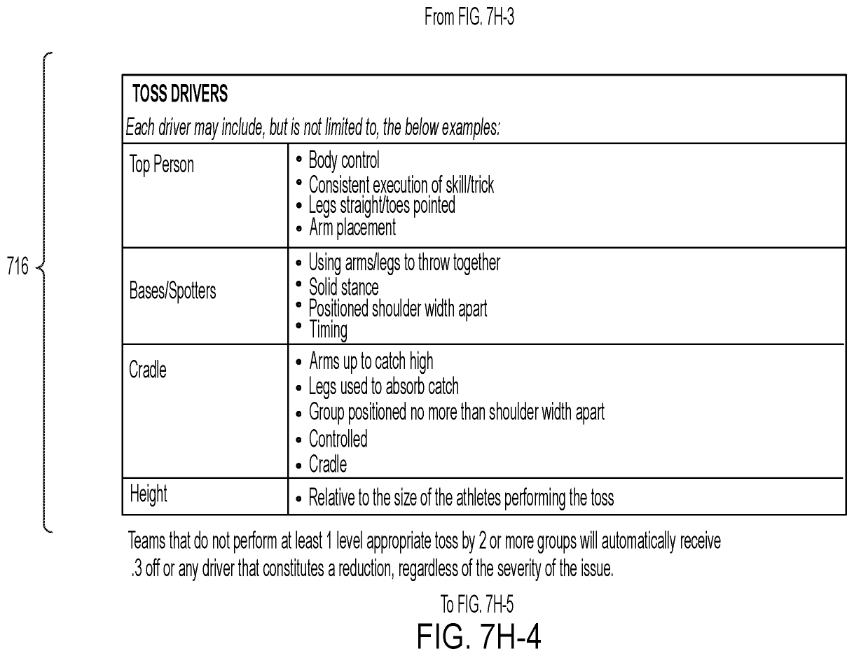

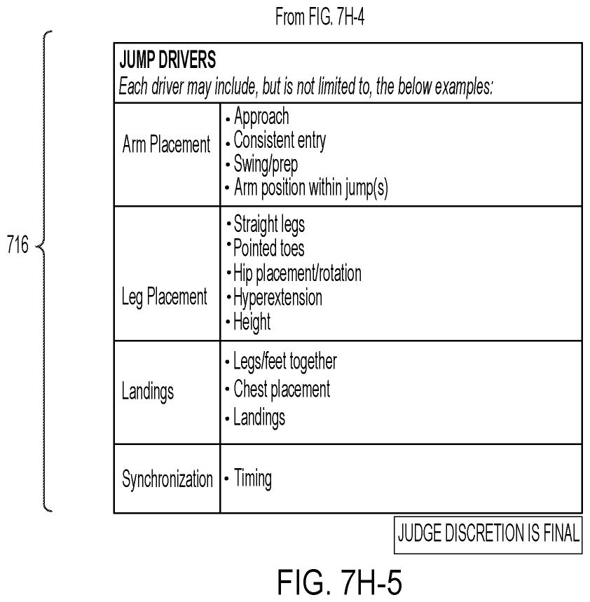

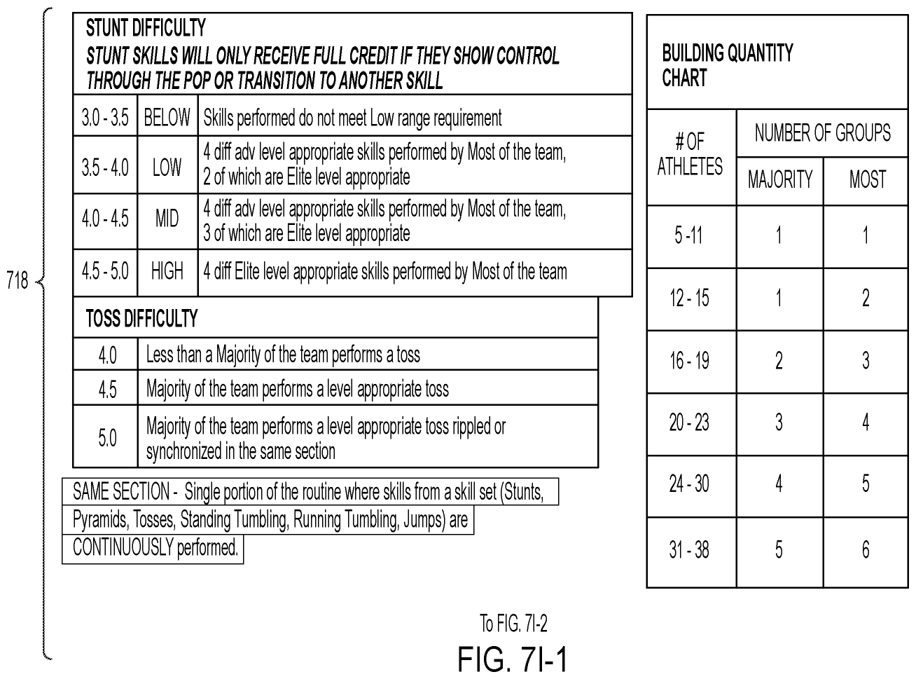

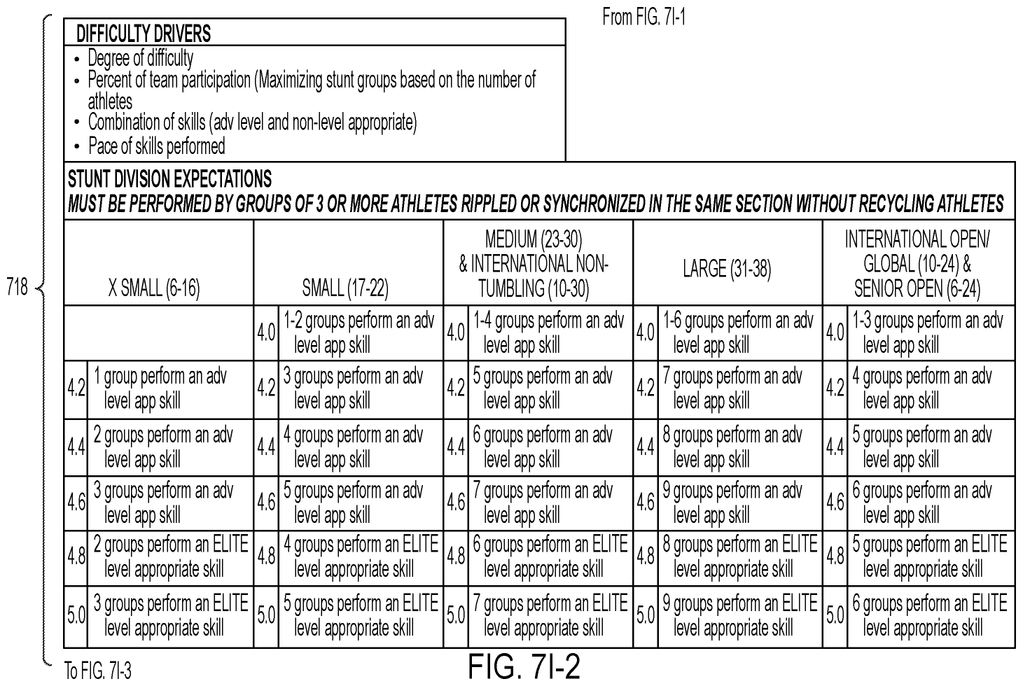

A performance score of the performance can be calculated based on a predefined set of criteria, rules and/or rubric. For example, the competition may be a cheerleading competition that is judged based on a number or parameters such as difficulty of stunts, height of a movement, number and quality of jumps, tumbling, number and quality of stunts, rhythm, originality, spirit, appearance, and unity. Exemplary depictions of one or more rubrics are shown in FIGS. 7A-7I.

For exemplary purposes, the system 100 will be described in relation to a cheerleading performance in the competition environment 101 to better illustrate the details and operation of the system and how the system 100 can be configured to operate. In a cheerleading competition, as illustrated in FIG. 1, a predetermined number of judges 108 and 104(a), 104(b), . . . 104(n), watch the cheerleading performance as it occurs live, that is, independent of any replay devices on the judging table. Each judge 108 and 104(a), 104(b), . . . 104(n) may be assigned one or more attributes of the performance to evaluate and score.

As shown in FIG. 1, a number of competitors 102 perform one or more cheerleading routines as the judges 108 and 104(a) . . . (n), evaluate the performance using notecards, paper, or input into a judge computing device 105(a) . . . (n) that can be any type of computing device that can communicate electronically with the system 100 and perform the operations of the present inventive disclosure. For example, the judge computing device 105(a) . . . (n) may be a desktop computer, a laptop computer, a mobile phone, a tablet, touch screen display, and the like. The judge computing devices 105(a) . . . (n) can communicate with the system 100 over any now known or hereafter developed method, device or system for communication between and among computing devices.

Referring next to FIG. 8, the overall function of the judges 104(a) . . . (n), 108 (including judges and administrators, coaches, and score checkers 124(a) is depicted. Each judge is responsible for judging a part of the performance. For example, judge 104(a) will judge the difficulty 802 of the performance, judge 104(b) will note each deduction 80 for the performance, and technique judge 108 will judge each technique 806 of the performance. Each judge provides their judging input using the judge computing device 105(a) . . . (n), that is received by the computer 123, also depicted as 810 in FIG. 8. A judge and/or administrator 808 administers the scoring and, using the inventive system 100, generates a coach review report 820 that may be reviewed at a score check 812 by a score checker 124(a). If approved by the score checker, the coach review report 820 is transmitted to the administrator as an approved coach review report 822. The administrator 808 transmits, using the inventive system and method, a performance packet report to a coach 824. Each judge 104 may be responsible for judging a part of the performance.

The performance is recorded by a recording device 106, which may be a camcorder, Iphone®, video camera or other audio/video recording device and communicated to the system 100 via wired or wireless communication channel 118. The system 100 can store a copy of the recorded performance, which can be accessed and view on the judge computing 105(a) . . . (n). Additionally, the system 100 can live stream the recorded performance to the judge computing devices 105(a) . . . (n), in real time. A technique judge 108, can also view the recorded performance (in real-time or at a later time) and make notations about the recorded performance. The technique judge 108 can add a timestamp to a particular part of the performance to indicate the precise time of a fault, deduction, or other indication by the judge 108.

The processor 121 and memory 122 may be portions of a computer 123 with adequate processing power and electronic memory capacity to store the recorded performance. The processor 121 and memory 122 may also be used to calculate scores and rankings of the various competitors. The processor 121 and memory 122 may transmit desired data to scoreboard 114 via wired or wireless communication channels. The processor 121 and memory 122 may also transmit desired data to a handheld device 128 viewed by a coach 126. The handheld device 128, such as a tablet or notebook is operatively wirelessly coupled to computer 123. The computer 123 can provide scoring information, judges' comments and placement information to the handheld device 128. The information provided to coaches' handheld device 128 may be all of the scoring information or a subset of the scoring information. A data filter may be present in computer 123 that filters data provided by processor 121 to handheld device 128.

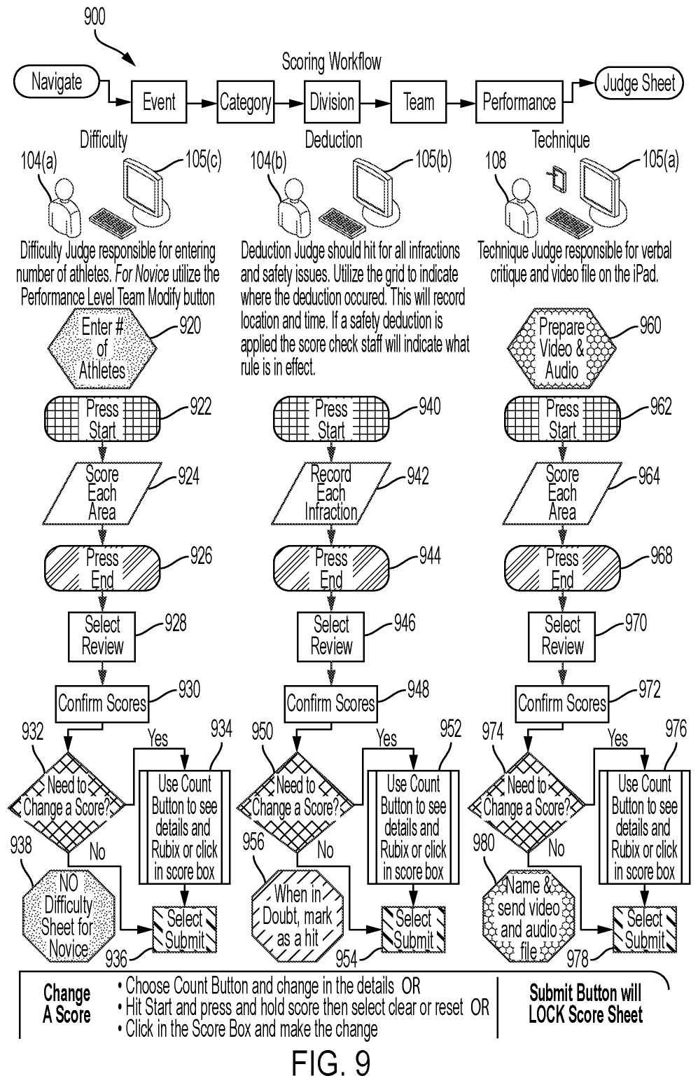

Referring next to FIG. 9, a scoring workflow 900 in accordance with embodiments of the present disclosure is depicted. A difficulty judge 104(a), a deduction judge 104(b) and a technique judge 108 are responsible for judging certain aspects of the performance. At 920, the difficulty judge 104(a) enters in the number of athletes in the performance, and then selects “Start” at 922. The judge 104(a) then judges and scores each area or part of the performance at 924 for difficulty. Once completed, at step 926 the difficulty judge 104(a) selects “End.” The difficulty judge 104(a) then selects “Review” at step 928 and confirms the scores at step 930. If the judge needs to change a score, as determined at step 932, the judge can use a “Count” button to see details of the performance, or click in the score box at step 934. Once completed, or if no score change was needed (at step 932) the judge can submit the score at step 936. Item 938 indicates that no difficulty scoring is done for novice performers.

At 940, the deduction judge 104(b) selects “Start” at 940. The judge 104(b) then judges and scores each area or part of the performance at 942 for deductions. Once completed, at step 944 the deduction judge 104(b) selects “End.” The deduction judge 104(a) then selects “Review” at step 946 and confirms the scores at step 948. If the judge needs to change a score, as determined at step 950, the judge can use a “Count” button to see details of the performance, or click in the score box at step 952. Once completed, or if no score change was needed (at step 950) the judge can submit the score at step 954. Item 956 indicates that the deduction judge 104(b) should mark aspects of the performance as a hit when in doubt as to whether a deduction applies.

At 960, the inventive system and method prepares video and audio of the performance. The technique judge 108 then selects “Start” at 962. The judge 108 then judges and scores each area or part of the performance at 964 watching the video and listening to the audio that may comprises, by way of non-limiting example, commentary created by one or more judges 104(a) . . . (n). Once completed, at step 968 the technique judge 108 selects “End.” The technique judge 104(a) then selects “Review” at step 970 and confirms the scores at step 972. If the judge needs to change a score, as determined at step 974, the judge can use a “Count” button to see details of the performance, or click in the score box at step 976. Once completed, or if no score change was needed (at step 974) the judge 108 can submit the score at step 978. At step 980 the video and/or audio file(s) of the performance are stored in memory 122 of the computer 123.

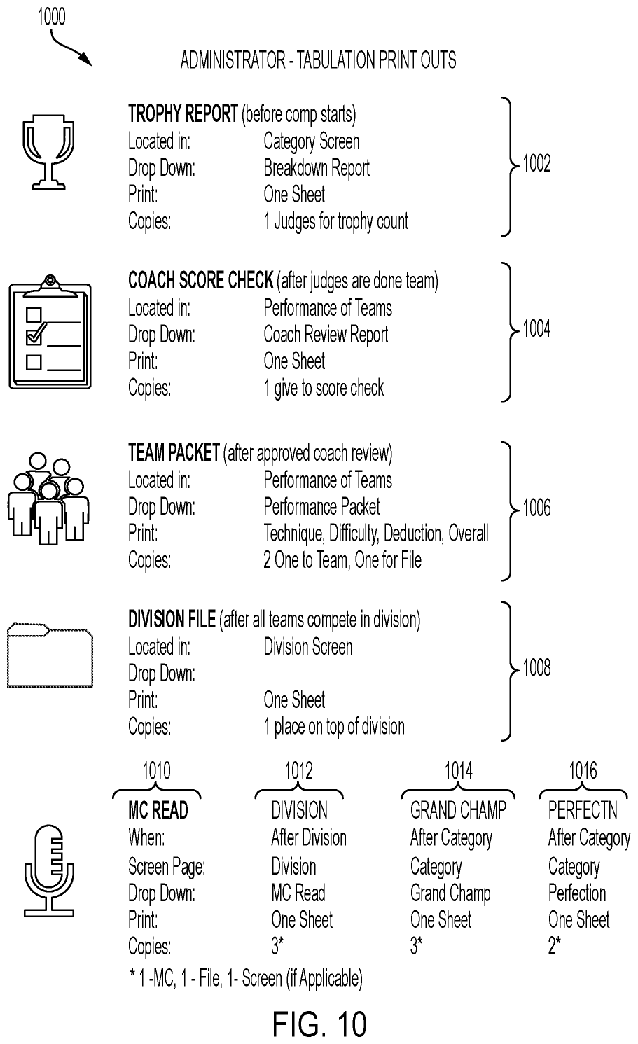

Referring next to FIG. 10, exemplary content provided in administrator and/or judge tabulation print-outs is depicted. At 1002, a Trophy Report print-out, generated before the competition starts, may be located in a Category Screen selection, accessed via a Breakdown Report drop down menu, may print as a single sheet, and may be printed as a single copy for judges' consideration for trophy count(s). At 1004, a Coach Score Check print-out, generated after the judges have finished judging a team's performance, may be located in a Performance of Teams selection, accessed via a Coach Review Report drop down menu, may print as a single sheet, and may be printed as a single copy for a score check. At 1006, a Team Packet print-out, generated after approved following a coach's review, may be located in a Performance of Teams selection, accessed via a Performance Packet drop down menu, may print technique, difficulty, deduction and overall score data entered by one or more judges, and may be printed as multiple copies, for example two, one team copy and one file copy. At 1008, a Division File print-out, generated after all teams in a division have competed their performances, may be located in a Division Screen selection, may print as a single sheet, and may be printed as a single copy for a top of division determination.

At 1010, 1012, 1014 and 1016, an announcer may read the results including Division, Grand Champion and Perfection awards.

In embodiments, as the performance begins, the system 100 can be configured to generate and provide one or more GUIs such as those depicted in FIGS. 6A-6M to be displayed on the judge computing devices 105(a) . . . (n) for viewing by the judges 108 and 104(a) . . . (n). The GUIs can be populated with widgets, fields, and boxes that describe the competition taking place and the categories being evaluated by the judges 108 and 104(a) . . . (n). The GUIs can be populated with widgets, fields, and boxes that allow the judges 108 and 104(a) . . . (n) to enter a score or evaluation for the categories. The GUIs can be populated windows that display a live stream of the performance or previously recorded portion of the performance.

The system 100 can be configured to automatically update the GUI as scores and evaluations are entered by the judges 108 and 104(a) . . . (n) using the judge computing devices 105(a) . . . (n).

In exemplary embodiments, the system 100, utilizing the processor 121, can be configured to receive from the memory 122 a performance to be judged as video data, receive attribute data of the performance and record a time stamp of a time the attribute data is received, determine a performance score based on the received attribute data, output on the display, in real time, the performance score; update the performance score based on a subsequently received attribute data, and continuously output on the display in real time the updated performance score. The attribute data can be any data representative of an attribute of the performance being judged, for example, a performance that is to be judged live. Exemplary attribute data can be e.g., stunt data, pyramid data, stunt quality data, standing tumbling data, running tumbling data, jumps data, routine composition data, performance data and/or dance data.

A performance score of the performance can be calculated based on a predefined set of criteria, rules and/or rubric. For example, the competition may be a cheerleading competition that is judged based on a number or parameters such as difficulty of stunts, height of a movement, number and quality of jumps, tumbling, number and quality of stunts, rhythm, originality, spirit, appearance, and unity.

In embodiments, as the performance proceeds live the judges 108 and 104(a) . . . (n) can type/tap the appropriate field, box, widget on the GUIs, thereby inputting attribute data into the system 100. Since the judges are entering attribute data in real time as the performance is occurring, the system receives and records a time stamp of a time the attribute data is received. Additionally, the evaluation and scores entered by the judges 108 and 104(a) . . . (n) can be cryptographically secured so that the evaluation and scores are uniquely associated with a particular judge. For example, a unique identifier can be appended to the evaluation or scores, and the combination encrypted using a public/private cryptographic scheme. Any type of know secure authentication scheme can be used by the system 100.

In embodiment, as the performance progresses, and as the judges 108 and 104(a) . . . (n) enter attribute data, evaluations, and scores into the system 100, the system 100 determines a performance score for the event being judged. That is, the processor 121 executes instructions stored in memory 122 that calculate the performance score based on criteria of the rubrics and judges' attribute data. The specific criteria or rubric in which the performance score is to be calculated is a predetermined criteria or rubric, which is stored in memory 122 and accessible for use in determining the performance score by the processor 121 in combination with the attribute data. The predetermined criteria or rubric may be set by the event organizers or may be an industry or organizational standard.

Additionally, a technique judge 108 may speak into a recording device as the routine progresses, providing notations of their impression of the routine as it occurs live while typing into an electronic form that is fillable, or making paper notations. Independent of the viewing judges, the performance is recorded, generating a recorded performance.

When the routine is complete, in embodiments, the live-viewing judges finish their evaluations and the calculated performance scores are sent to processor 121, or other repository, to be checked by authorized score-checking. Score checking personnel, or score checkers, 124(a) . . . (n) review the recorded performance and the judges' scores to confirm accuracy and determine whether any errors were made in either the judging process, or computation of the calculated performance scores. In case of error or inaccuracy, a score checker 124 can enter revised data into the system 100 and the processor 121 recalculates the score. The score checker 124 also reviews any deductions made by the judges 104(a) . . . (n), 108 and confirms whether the notated deductions were true infractions or athlete error. Rubrics assigned to the performance can then be double checked if an error is found. The confirmed performance scores, which are based on the attribute data and judges' data are then printed for the coaches. If there are questions the score checkers 124 can review the score sheets and recorded performance with the coach and discuss any perceived discrepancies. Tabulation of the scores and order placement for awards are done within the system, which may be a computer or hand calculation.

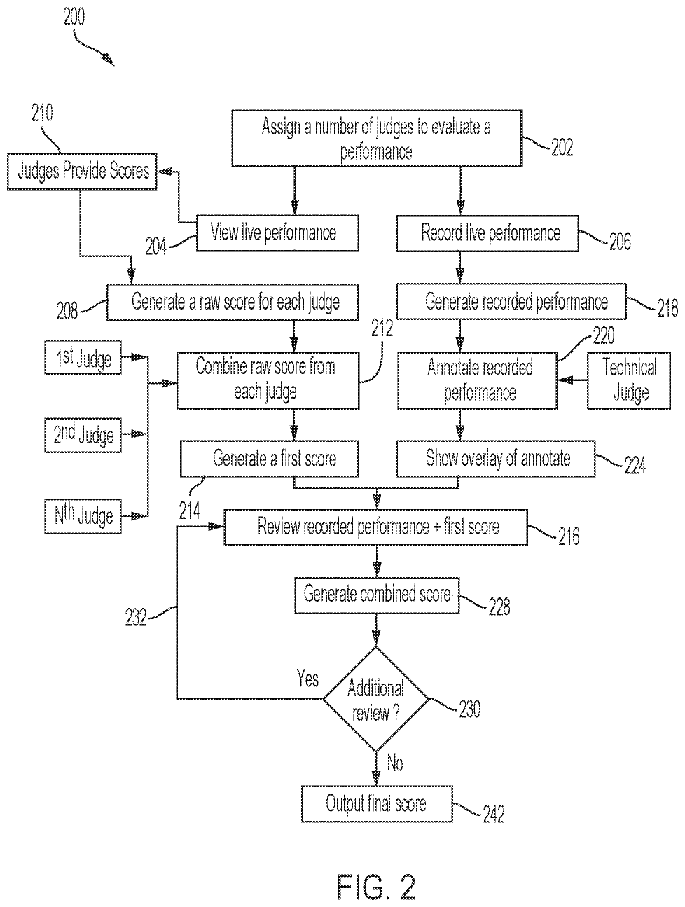

Referring next to FIG. 2, a method for generating a real-time score of a performance 200 in accordance with an embodiment of the present disclosure will be discussed in detail. The inventive method disclosed in FIG. 2 is carried-out by the processor 121 of the computer 123 executing instructions stored in memory 122 that may comprise a series of steps for generating a real-time score of a performance in accordance with the disclosure of FIG. 2. A performance is judged by a predetermined number of judges assigned to judge the performance at step 202. Each judge may judge a specific part or parts of the performance, such as, by way of non-limiting example, one or more judges may evaluate a specific portion, or attribute, or stunt, or parameter of the performance. By way of further non-limiting example, one judge may be responsible for presentation, another judge may be responsible for execution and yet another judge may be responsible for identifying faults in the routine. Note the terms “performance” and “routine” are used interchangeably herein unless otherwise indicated. Some judges view the live performance in real-time at step 204. At step 210, each judge viewing the live performance provides their score, via a judge computing device 104. At step 208 a raw score is created for each judge that may be a numerical sum of one or more scores entered by a judge, a sum of raw scores and weighted average of one or more scores entered by a judge, as two illustrative and non-limiting examples. At step 212 a combined raw score is created from the combination of all judges individual scores. The raw score from each judge is combined at step 212, and a first score is generated for the performance at step 214. For example, the raw score represents a score by a judge based on the judge's evaluation of the live performance. The raw score from each judge is combined by the processor 121 executing instructions stored in memory 122 that may comprise a series of steps to use the judges' scores and other data on a scoring rubric to generate the first score at step 214.

Simultaneously to the judge's watching and scoring the performance (e.g., steps 204, 210), at step 206 the performance is recorded by any now known or hereafter developed audio/video recording device, generating a performance recording a step 218. At step 220, a judge, such as, for example, a technique judge, may annotate the recording with comments, notes, notations, annotations, etc. directed to a specific part of the performance, e.g., typically an error, missing essential element, etc. A time stamp may be associated with the comment manually, e.g., by the technique judge, or automatically, e.g., by instructions stored in memory 122 executed by the processor 121. The time stamp correlates the comment with a specific point in the recording at which the subject of the judge's comments occurred. At step 224, the annotations, or comments, may be overlayed on the performance recording and displayed on the monitor of the judge computing device 104 or other suitable audio/visual display device.

At step 216, one or more judges may review the recording of the performance and the initial score for the performance, and create a combined score at step 228. At step 230, whether additional review of the performance and combined score is required is determined based upon a request from a coach, one or more judges, or other person or means for assessing the apparent validity of a score of the performance. If additional review is required, the method returns to step 216, where one or more judges again review the recording of the performance and the initial score for the performance, and create a recalculated combined score at step 228. If additional review is not required, a final score is output at step 242 to one or more display devices such as, by way of non-limiting example, a scoreboard 114, display of a judge computing device 105, or display of a coach computing device 128. At step 242 the final score is also written to memory 122 of the computer 123 of the inventive system 100.

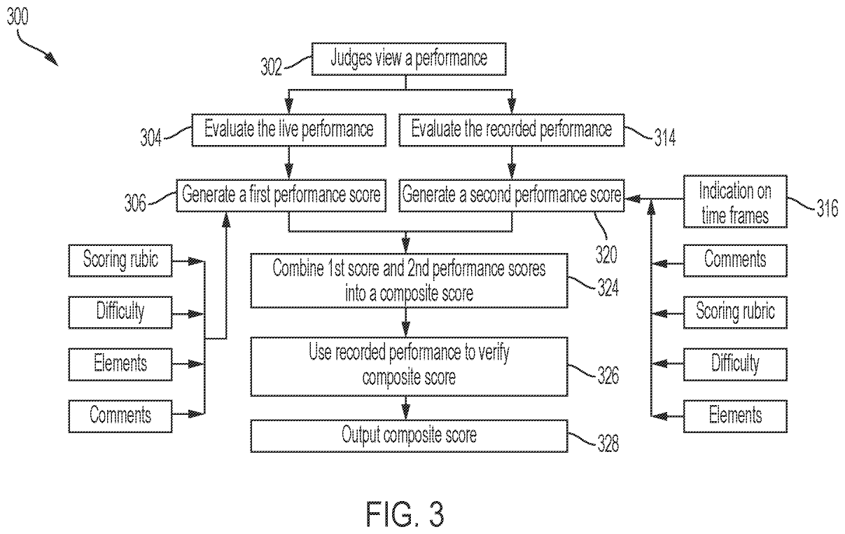

Referring next to FIG. 3, a method for generating a real-time score of a performance 300 in accordance with an embodiment of the present disclosure will be discussed in detail. The inventive method disclosed in FIG. 3 is carried-out by the processor 121 of the computer 123 executing instructions stored in memory 122 that may comprise a series of steps for generating a real-time score of a performance in accordance with the disclosure of FIG. 3.

One or more judges view a live performance of an event and/or a recorded performance of the event at step 302, and evaluate the live performance at step 304, and the recoded performance at step 314. When evaluating the performance a judge may observe, evaluate and/or record as data one or more characteristics of the performance including, by way of non-limiting example, data from a scoring rubric, a difficulty level, presentation and technical execution rating, whether certain elements of the performance were included and/or completed, comments entered by the judge, and other characteristics of each judge's qualitative and quantitative assessment of the performance. Each or any of the foregoing or any other data created by a judge in observing and assessing the performance may be entered by a judge an electronic form, or input from a paper score sheet using the judge computing device 105 and stored in memory thereof and/or in memory 122 of the computer 123.

At step 306 a first performance score is generated by the processor 121 of the computer 123 executing instructions stored in memory 122 that may comprise a series of steps to use the data entered by a judge. The first performance score may be based on one or more judges and one or more data observed and entered by each judge of the live performance. The first performance score may be generated by the processor 121 of the computer 123 executing instructions stored in memory 122 that may comprise a series of steps to use each judge's data.

At step 320 a second performance score is generated by the processor 121 of the computer 123 executing instructions stored in memory 122 that may comprise a series of steps to use the data entered by a judge. The second performance score may be based on one or more judges and one or more data observed and entered by each judge of the recorded performance. In generating the second performance score, the inventive method considers comments, one or more rubrics, difficulty level, elements required of the performance, and other attributes relating to judging the performance. One or any of the foregoing may be associated with a time stamp indicating the location in the recorded performance to which the attribute applies. The second performance score may be generated by the processor 121 of the computer 123 executing instructions stored in memory 122 that may comprise a series of steps to use each judge's data.

As part of a judge observing and evaluating the recorded performance the judge may provide comments, make indications, or otherwise record their subjective evaluation of the recorded performance on a score card, or make marks or notations on the recorded performance, which may be viewed by a score-checker and/or coach. The one or more second judges can indicate notations using a time stamp for a significant portion or fault, or other judging indication.

The first score and the second performance scores are combined at step 324 by the processor 121 of the computer 123 executing instructions stored in memory 122 to generate a composite or final score. The combing of scores may include accessing the recorded performance to verify either the first performance score or second performance score, or both the first performance score and the second performance score at step 326. At step 328 the composite or final score is output to one or more display devices such as, by way of non-limiting example, a scoreboard 114, display of a judge computing device 105, or display of a coach computing device 128. At step 328 the composite or final score is also written to memory 122 of the computer 123 of the inventive system 100.

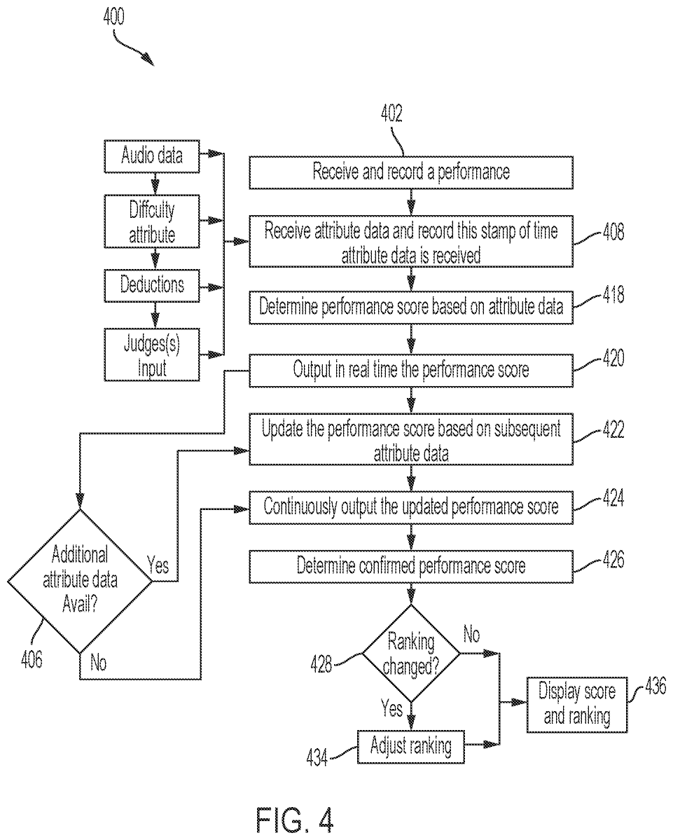

Referring next to FIG. 4, a method for generating a real-time score of a performance 400 in accordance with an embodiment of the present disclosure will be discussed in detail. The inventive method disclosed in FIG. 4 is carried-out by the processor 121 of the computer 123 executing instructions stored in memory 122 that may comprise a series of steps for generating a real-time score of a performance in accordance with the disclosure of FIG. 4.

At step 402 a real-time recording of the performance is received by the computer 123 from the recording device 106, as a non-limiting example. The real-time recording may be displayed on display 110, display of a judge computing device 105, or other suitable video display device. The recording may also be stored in memory 122 of computer 123. Certain data associated with the recording may also be received and displayed and/or stored. This may occur either after the reception and recordation of the performance at step 402 or after receiving the attribute data at step 408.

At step 408 attribute data created by one or more judges is received by the computer 123 from the one or more judge computing devices 105. Illustrative and non-limiting examples of attribute data include a difficulty rating, deductions, technique assessment that may include a judge's audio commentary, and other attributes that would be obvious to a person of skill in the art and from the disclosure provided herein. Also, at step 408 the computer 123, executing instructions stored in memory 122 time stamp the attribute data and associate it with the real-time recording. For example, a judge watching the performance live or on video wants to note something about the performance such as, for example, a level of execution of a technique. The judge, using a judge computing device 105 creates and enters attribute data that is transmitted to the computer 123 and associated with specific time, i.e., time-stamped, of the recording of the performance. The judge's opinion of a specific part of the performance is thus captured and associated with the recording of the performance so that another judge or the same judge can review the performance and consider the view of a judge who created a real-time attribution of that specific part of the performance.

Attribute data such as audio data, e.g., commentary of one or more judges, difficulty level of the attribute, deductions, and input from one or more judges may comprise attribute data. This attribute data may be categorized as judge's impression of the performance. The attribute data may be used as, in part, a basis for an evaluation of the performance.

At step 418, the computer 123, executing instructions stored in memory 122 and using the attribute data determines a performance score. Alternatively, the performance score can be hand-calculated by one or more judges using the attribute data.

The performance score determined at step 418 is output in real-time to one or more display devices at step 420.

Additional attribute data may be available, as determined at step 406. If additional attribute data is available, the inventive method updates the performance score using the additional attribute data at step 422. The inventive method then continuously outputs the performance score, that may or may not be an updated performance score, at step 424. If additional attribute data is not available, the inventive method continuously outputs the performance score, that may or may not be an updated performance score, at step 424.

A confirmed performance score may be determined based on the attribute data, video data and audio data at step 426.

At step 428 the inventive method determines whether the confirmed performance score changes the ranking, or place of the competitor, or team. If it does change the ranking, the ranking is adjusted at step 434 and then output to a display at step 436. If it does not change the ranking, as determined at step 428, the ranking is output to a display at step 436.

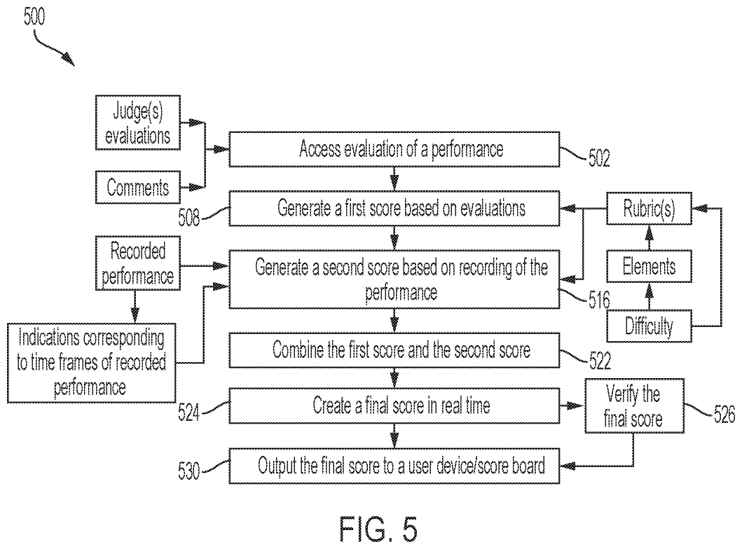

Referring next to FIG. 5, a method for generating a real-time score of a performance 500 in accordance with an embodiment of the present disclosure will be discussed in detail. The inventive method disclosed in FIG. 5, and in each of FIGS. 2, 3 and 4, may be carried out by the processor 121 executing instructions stored in memory 122 that may comprise a series of steps for generating a real-time score of a performance in accordance with the disclosure of FIG. 5.

At step 502, one or more evaluations created by one or more judges is accessed and evaluated. In this context, “evaluations” means the criteria, data, etc. entered by a judge watching the live performance while judging the performance. For example, one or more judges, each with a specific responsibility for judging a specific part of the performance, may provide comments while viewing and judging the performance, the comments being entered by the judge via the judge computing device 104.

At step 508 the inventive method generates a first score of the performance based upon the one or more evaluations accessed at step 502. The first score is generated by the processor 121 executing instructions stored in memory 122 using the input data from the judges to calculate a score. The inventive method uses weights, or multiples to factor level of difficulty, percentage of the total score and other parameters to generate the first score. For example, the first score can be generated based on a rubric which assigns a score based on one or more parameters of a performance. Additionally, the first score can be generated by various parameters performed during the performance and/or identified by the judges, such as stunts, difficulty, number of athletes, team level, execution, etc.

A way to validate the first score in accordance with embodiments of the present invention is to generate a second score from the recorded performance that includes indications created by one or more judges corresponding to time frames of the recorded performance. The second score can be the first score after being reviewed, verified or modified based, at least in part, on the recorded performance, as well as indications corresponding to time frames of the recorded performance. The second score can be generated by the processor 121 executing instructions stored in memory 122 similar to that used for the first score and/or in addition to the recorded performance.

In accordance with embodiments of the present invention, a method for generating a real-time score of a performance may use rubrics, evaluation of elements or attributes required in the performance, and/or difficulty levels, as illustrative, non-limiting examples to generate the first score and/or the second score. The rubrics may be fillable electronic forms, paper forms or other schedule of parameters for judging a performance. The elements or attributes may be parts of a routine or other factors that can impact a score. For example, an element, or attribute may be a stunt or movement that if completed can increase a competitor's score. Difficulty may be a difficulty level or enhancement that can increase a competitor's score.

At step 522 the first score and the second score are combined to generate a final score in real-time at step 524.

The final score may be output to an output device at step 530. Alternatively, or in addition the final score may be verified at step 526 and the verified score output to an output device at step 530.

According to yet another embodiment, the recorded performance can be used to educate and train judges, coaches and/or competitors. The recorded performance can be transmitted and/or stored in an electronic memory. The recorded performance may include notations, written comments, audible comments and other indications made by one or more judges who evaluated the performance over an entire duration of the performance. By accessing this annotated recorded performance judges, either new or experienced, can study the notations, written comments, audible comments, scores and other indications made by the judges who evaluated the performance at various time intervals of the performance. This annotated recorded performance may also be used by coaches and competitors to learn and understand the criteria for judging as well as showing areas for improvement in the future, including various aspects or time periods of a performance.

As described herein, there is disclosed a method and system for generating a real-time score of a performance. In an embodiment the inventive method comprise generating, by a processor of a computing device, a first score of the performance based upon a score from a first judge, generating, by the processor, a second score of the performance, combining, by the processor, the first score and the second score into a combined score, generating, by the processor, a final score from the combined score, and outputting in real-time, by the processor, the final score to a display.

In an embodiment of the inventive method, the second score of the performance is based upon a score from a second judge having viewed a recording of the performance.

An embodiment of the inventive method further comprises verifying, by the processor, one of the first score, the second score and the combined score using the recording of the performance.

In an embodiment of the inventive method, the score from the first judge is created by the first judge using at least one scoring rubric corresponding to the performance, and wherein the step of generating a first score further comprises accessing, by the processor, the at least one scoring rubric stored in memory of the computing device and using the at least one scoring rubric to generate the first score.

In an embodiment of the inventive method, the at least one scoring rubric includes a plurality of criteria that include a plurality of elements and a difficulty level corresponding to each element.

In an embodiment of the inventive method, the step of generating a first score further comprises generating, by a processor of a computing device, a first score of the performance based upon a score from the first judge having viewed the performance live and having judged the performance using at least one scoring rubric corresponding to the performance.

In an embodiment of the inventive method, the step of generating, by the processor, a second score of the performance based upon a recording of the performance, further comprises receiving, by the processor, the recording, storing, by the processor, the recording in a memory of the computing device, receiving, by the processor, attribute data associated with the performance, time-stamping, by the processor, the attribute data, and generating, by the processor, the second score based upon the attribute data.

An embodiment of the inventive method further comprises determining, by the processor, whether additional attribute data of the performance is available, updating, by the processor, the final score when additional attribute data is available, outputting, by the processor, an updated final score, determining, by the processor, whether a competitor ranking has changed based upon the updated final score, adjusting, by the processor, the ranking of the competitor when that ranking has changed, and outputting in real-time, by the processor, the updated final score and changed ranking to a display.

In an embodiment of the inventive method the one scoring rubric corresponding to the performance used by the judge enables the judge to deduct points when judging the performance.

An embodiment of the inventive method is directed to generating a real-time score of a performance comprising judging a performance comprising: a memory for storing data in an electronic form; a display; and a processor operatively in communication with the memory and the display. The processor is configured to: receive in the memory a performance to be judged as video data; receive attribute data of the performance and record a time stamp of a time the attribute data is received; determine a performance score based on the received attribute data; output on the display, in real time, the performance score; update the performance score based on a subsequently received attribute data; and continuously output on the display in real time the updated performance score.

Another embodiment is directed to the system where the processor is further configured to receive, in memory, audio data associated with the attribute data.

Another embodiment is directed to the system wherein the processor is further configured to determine a confirmed performance score based on the attribute data, the video data, and the audio data.

Another embodiment is directed to the system wherein the processor is further configured to determine a confirmed performance score based on the attribute data and the video data.

Another embodiment is directed to the system wherein the processor is further configured determine a video data set of the video data associated with the attribute data and output a representative image of the video data set adjacent the attribute data associated with the video data set.

Another embodiment is directed to the system wherein the processor is further configured determine a video data set of the video data associated with the attribute data and output a representative image of the video data set adjacent the attribute data associated with the video data set, and the time stamp of the attribute data.

Another embodiment is directed to the system wherein the processor is configured to receive a plurality of attribute data.

Another embodiment is directed to the system wherein the plurality of attribute data comprises difficulty attribute data and deduction attribute data.

Another embodiment is directed to a method of producing a performance event comprising: assigning a judge to judge an attribute of a performance and inputting the attribute data of the attribute into the system, as described above; using the system to output on the display in real time the updated performance score; and modifying a placement based on the real time updated performance score.

Another embodiment is directed to the method further comprising: assigning a first judge to judge a difficulty attribute of the performance; and assigning a second judge to judge a deduction attribute of the performance.

Another embodiment is directed to the method further comprising: assigning a single judge to judge a difficulty attribute of the performance; and assigning a single judge to judge a deduction attribute of the performance.

Another embodiment is directed to a method for judging a performance comprising: accessing evaluations of the performance, the evaluations based on live viewing the performance by one or more judges, each judge having responsibility to evaluate a specific attribute of the performance; generating a first score of the performance based, at least in part, on the evaluations; generating a second score of the performance based, at least in part, on a recording of the performance; combining the first score and the second score to generate a final score; and outputting the final score to a user device.

Another embodiment is directed to the method for judging a performance, further comprising: generating one or more indications corresponding to one or more time frames of the recorded performance; and utilizing the indications to generate the second score.

Another embodiment is directed to the method for judging a performance further comprising notating the indications with comments indicating impressions by the one or more judges.

Another embodiment is directed to the method for judging a performance further comprising: accessing one or more scoring rubrics corresponding to the performance; and using the one or more scoring rubrics to generate the first score and the second score.

Another embodiment is directed to the method for judging a performance wherein the scoring rubric includes a plurality of criteria that include a plurality of elements and a difficulty level corresponding to each element.

Another embodiment is directed to the method for judging a performance further comprising utilizing the recorded performance to verify the first score, the second score and the final score.

Another embodiment is directed to the method for judging a performance wherein one or more of the first score or the second score is based, at least in part, on deducting points.

Program code for carrying out operations for aspects of the present disclosure may be generated by any combination of one or more programming language types, including, but not limited to any of the following: machine languages, scripted languages, interpretive languages, compiled languages, concurrent languages, list-based languages, object oriented languages, procedural languages, reflective languages, visual languages, or other language types. Program instructions may include a computer program, which in certain forms is known as a program, software, software application, script, or code.

The functions performed in the above-described processes and methods may be implemented in differing order. Furthermore, the outlined steps and operations are only provided as examples. Some of the steps and operations may be optional, combined into fewer steps and procedures, or expanded into additional steps and procedures without detracting from the disclosed embodiments' essence.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject disclosure as defined by the appended claims.

What is claimed is:

1. A method for generating a real-time score of a performance comprising:
generating, by a processor of a computing device, a first score of the performance based upon a score from a first judge;
generating, by the processor, a second score of the performance;
combining, by the processor, the first score and the second score into a combined score;
generating, by the processor, a final score from the combined score; and
outputting in real-time, by the processor, the final score to a display.

2. The method of claim 1, wherein the second score of the performance is based upon a score from a second judge having viewed a recording of the performance.

3. The method of claim 2, further comprising verifying, by the processor, one of the first score, the second score and the combined score using the recording of the performance.

4. The method of claim 1, wherein the score from the first judge is created by the first judge using at least one scoring rubric corresponding to the performance, and wherein the step of generating a first score further comprises:
accessing, by the processor, the at least one scoring rubric stored in memory of the computing device; and
using the at least one scoring rubric to generate the first score.

5. The method of claim 4, wherein the at least one scoring rubric includes a plurality of criteria that include a plurality of elements and a difficulty level corresponding to each element.

6. The method of claim 1, wherein the step of generating a first score further comprises generating, by a processor of a computing device, a first score of the performance based upon a score from the first judge having viewed the performance live and having judged the performance using at least one scoring rubric corresponding to the performance.

7. The method of claim 2, wherein the step of generating, by the processor, a second score of the performance based upon a recording of the performance, further comprises:
receiving, by the processor, the recording;
storing, by the processor, the recording in a memory of the computing device;
receiving, by the processor, attribute data associated with the performance;
time-stamping, by the processor, the attribute data; and
generating, by the processor, the second score based upon the attribute data.

8. The method of claim 7, further comprising:
determining, by the processor, whether additional attribute data of the performance is available;
updating, by the processor, the final score when additional attribute data is available;
outputting, by the processor, an updated final score;
determining, by the processor, whether a competitor ranking has changed based upon the updated final score;
adjusting, by the processor, the ranking of the competitor when that ranking has changed; and
outputting in real-time, by the processor, the updated final score and changed ranking to a display.

9. The method of claim 4, wherein the one scoring rubric corresponding to the performance used by the judge enables the judge to deduct points when judging the performance.

10. A non-transitory computer-readable storage medium storing instructions that, when executed by a processor, cause a system to perform operations comprising:
generating, by a processor of a computing device, a first score of the performance based upon a score from a first judge;
generating, by the processor, a second score of the performance;
combining, by the processor, the first score and the second score into a combined score;
generating, by the processor, a final score from the combined score; and
outputting in real-time, by the processor, the final score to a display.

11. The non-transitory computer-readable storage medium of claim 10, wherein the second score of the performance is based upon a score from a second judge having viewed a recording of the performance.

12. The non-transitory computer-readable storage medium of claim 11, further comprising verifying, by the processor, one of the first score, the second score and the combined score using the recording of the performance.

13. The non-transitory computer-readable storage medium of claim 10, wherein the score from the first judge is created by the first judge using at least one scoring rubric corresponding to the performance, and wherein the step of generating a first score further comprises:
accessing, by the processor, the at least one scoring rubric stored in memory of the computing device; and
using the at least one scoring rubric to generate the first score.

14. The non-transitory computer-readable storage medium of claim 13, wherein the at least one scoring rubric includes a plurality of criteria that include a plurality of elements and a difficulty level corresponding to each element.

15. The non-transitory computer-readable storage medium of claim 10, wherein the step of generating a first score further comprises generating, by a processor of a computing device, a first score of the performance based upon a score from the first judge having viewed the performance live and having judged the performance using at least one scoring rubric corresponding to the performance.

16. The non-transitory computer-readable storage medium of claim 11, wherein the step of generating, by the processor, a second score of the performance based upon a recording of the performance, further comprises:
receiving, by the processor, the recording;
storing, by the processor, the recording in a memory of the computing device;
receiving, by the processor, attribute data associated with the performance;
time-stamping, by the processor, the attribute data; and
generating, by the processor, the second score based upon the attribute data.

17. The non-transitory computer-readable storage medium of claim 16, further comprising:
determining, by the processor, whether additional attribute data of the performance is available;
updating, by the processor, the final score when additional attribute data is available;
outputting, by the processor, an updated final score;
determining, by the processor, whether a competitor ranking has changed based upon the updated final score;
adjusting, by the processor, the ranking of the competitor when that ranking has changed; and
outputting in real-time, by the processor, the updated final score and changed ranking to a display.

18. The non-transitory computer-readable storage medium of claim 13, wherein the one scoring rubric corresponding to the performance used by the judge enables the judge to deduct points when judging the performance.

19. A system for generating a real-time score of a performance comprising:
a non-transitory computer-readable medium with instructions encoded thereon;
a display; and
one or more processors operatively in communication with the non-transitory computer-readable medium and the display, and configured to, when executing the instructions, perform operations of:
generating, by a processor of a computing device, a first score of the performance based upon a score from a first judge;
generating, by the processor, a second score of the performance;
combining, by the processor, the first score and the second score into a combined score;
generating, by the processor, a final score from the combined score; and
outputting in real-time, by the processor, the final score to a display;
wherein the step of generating, by the processor, a second score of the performance based upon a recording of the performance, further comprises:
receiving, by the processor, the recording;
storing, by the processor, the recording in a memory of the computing device;
receiving, by the processor, attribute data associated with the performance;
time-stamping, by the processor, the attribute data; and
generating, by the processor, the second score based upon the attribute data.

20. The system of claim 19, wherein the one or more processors is further configured to, when executing the instructions to perform operations of:
determining, by the processor, whether additional attribute data of the performance is available;
updating, by the processor, the final score when additional attribute data is available;
outputting, by the processor, an updated final score;
determining, by the processor, whether a competitor ranking has changed based upon the updated final score;
adjusting, by the processor, the ranking of the competitor when that ranking has changed; and
outputting in real-time, by the processor, the updated final score and changed ranking to a display.
